(19) United States
(12) Patent Application Publication
(10) Pub. No.: US 2023/0410590 A1
(43) Pub. Date: Dec. 21, 2023

(54) SELF SERVICE KIOSK

(71) Applicant: SLEEGERS ENGINEERED PRODUCTS, INC., London (CA)

(72) Inventors: Daniel Harry GRANGER, London (CA); Michael Richard GOWMAN, London (CA); Taylor Daniel GRANGER, London (CA); Robert Frank COSTA, London (CA)

(21) Appl. No.: 18/249,852

(22) PCT Filed: Oct. 21, 2021
(86) PCT No.: PCT/CA2021/051481

§ 371 Date: Apr. 20, 2023

Related U.S. Application Data
(60) Provisional application No. 63/242,822, filed on Sep. 10, 2021.
(60) Provisional application No. 63/119,214, filed on Nov. 30, 2020.
(60) Provisional application No. 63/094,569, filed on Oct. 21, 2020.

(51) Int. Cl. G07F 13/10; G07F 9/02; G07F 9/00

(52) U.S. Cl. CPC G07F 13/10; G07F 9/023; G07F 9/001

(57) ABSTRACT

A dispensing machine is provided comprising a main frame with a bottom wall, top wall and side walls defining an enclosure for storage and dispensing of containers. A carousel is rotatably mounted atop said bottom wall about a vertical axis of rotation, said carousel having a plurality of separate compartments located around said axis for receiving a container in a compartment. A door is hingedly mounted to said main frame and movable to and from an open position allowing access to said compartment and a closed position limiting access to said compartment. A driver is mounted on said main frame and engaged with said carousel for drivingly rotating said carousel about said axis and position the compartment behind the door.

### CROSS REFERENCE TO RELATED APPLICATIONS

This application is a non-provisional of, and claims all benefit, including priority, to U.S. Application No. 63/094,569, dated Oct. 21, 2020; U.S. Application No. 63/119,214, dated Nov. 30, 2020; and U.S. Application No. 63/242,822, dated Sep. 10, 2021; each entitled SELF SERVICE KIOSK and incorporated herein in their entirety by reference.

### FIELD

This disclosure relates generally to dispensing means, and in particular, dispensing machines for objects such as propane cylinders.

### BACKGROUND

Various types of enclosures have been designed to hold cylinders of Liquefied Petroleum Gas (LPG). In the propane cylinder exchange market there are conventional cages that hold full and empty cylinders in a locked environment outside of buildings due to safety concerns and industry code requirements. Customers desiring an exchange or purchase of a propane cylinder must interact with location personnel who provide access to the secure cylinders as they facilitate the transaction. To facilitate the transaction a person is required to open the secure cage enclosure and remove the full cylinder and, if applicable, store the empty cylinder being returned by the customer. The cost and labour associated with servicing customers using these secure cages has resulted in the evolution of self-serve cabinets or kiosks also located external to the building. Utilizing a locker style self serve kiosk, the customer can access a full cylinder from the kiosk by payment instrument or pre-purchased authorization codes and if need be, can also return an empty cylinder. In general, the “locker-based” self-serve kiosk cabinets can be quite long if they facilitate a large number of cylinders to be stored on site to avoid high re-stocking frequencies. This results in an inefficient use of space. Moreover, for each locker door, sensors are needed to detect the tank and if a door is open or closed, and an actuator is needed to unlock the door. Such configuration may be expensive and may introduce more failure points.

### SUMMARY

In some embodiments, there is provided a dispensing machine comprising a main frame with a bottom wall, top wall and side walls defining an enclosure for storage and dispensing of containers of product which require storage conditions that satisfy requirements of a hazardous environment, a carousel rotatably mounted atop said bottom wall about a vertical axis of rotation, a door hingedly mounted to said main frame and movable to and from an open position allowing access to said compartment and a closed position limiting access to said compartment, and a driver mounted on said main frame and engaged with said carousel for drivingly rotating said carousel about said axis, and positioning the compartment behind the door. The carousel has a plurality of separate compartments located around said axis for receiving a container in a compartment.

In some embodiments, there is provided a method of vending product which require storage conditions that satisfy requirements of a hazardous environment. The method comprises receiving a hydrocarbon reading from a hydrocarbon sensor in a dispensing machine. When the level of hydrocarbons is below a threshold, the method comprises confirming that the dispensing machine is safe to vend, or sending or displaying a message to continue operation. When the level of hydrocarbons is above the threshold, the method comprises confirming that the dispensing machine is unsafe to vend, sending or displaying a warning message, shutting down or transitioning the dispensing machine to a safe mode, or stopping any current operation of the dispensing machine.

In some embodiments, there is provided a method of vending product. The method comprises processing a financial transaction, determining an available full container to vend, signalling a door associated with a compartment containing the full container to open, and displaying instructions to remove the full container.

In some embodiments, there is provided a method of refilling a dispensing machine used to vend product which require storage conditions that satisfy requirements of a hazardous environment. The method comprises checking an inventory of the dispensing machine, and for each compartment on a carousel containing no container or an empty container: rotating a carousel of the dispensing machine such that a door is aligned with that compartment, signaling the door to open, receiving confirmation that the compartment contains a full container, and receiving confirmation that the door is closed.

In some embodiments, there is provided another dispensing machine comprising a main frame with a bottom wall, top wall and side walls defining an enclosure for storage and dispensing of cylinders. A carousel is rotatably mounted atop said bottom wall about a vertical axis of rotation, said carousel having a plurality of separate compartments (or shelves, bays, etc.) located around said axis for receiving a cylinder in a compartment. A door is hingedly mounted to said main frame and movable to and from an open position allowing access to said compartment and a closed position limiting access to said compartment. A driver is mounted on said main frame and engaged with said carousel for drivingly rotating said carousel about said axis bidirectionally and position the compartment behind the door.

In some embodiments, the driver comprises a small motor (e.g., a small servo motor) coupled with a power transmission system yielding the mechanical advantage required to drive the system.

In some embodiments, a locking mechanism is mounted on said main frame and releasably engageable with said carousel limiting movement of said carousel.

In some embodiments, there is provided another dispensing machine comprising a main frame with a bottom wall, top wall and side walls defining an enclosure for storage and dispensing of cylinders. A carousel is rotatably mounted atop said bottom wall about a vertical axis of rotation, said carousel having a plurality of separate shelves located around said axis on a plurality of levels located along said axis for receiving a single cylinder on each shelf. A door is hingedly mounted to said main frame and movable to and from open positions allowing access to said shelves and closed positions limiting access to said shelves. A driver is mounted on said main frame and engaged with said carousel for drivingly rotating said carousel about said axis bidirectionally or unidirectionally and position a compartment behind each door. A locking mechanism is mounted on said main frame and releasably engageable with said carousel limiting movement of said carousel.

In some embodiments, a carousel-based self-serve kiosk for storing and dispensing cylinders is provided, including a main frame that has a bottom wall, top wall, side walls, front wall and back wall defining an enclosure for storage and dispensing of cylinders. A carousel is rotatably mounted atop the bottom wall about a vertical axis of rotation. The carousel has a plurality of separate shelves located around the axis with the levels located along the axis. A plurality of doors are hingedly mounted to the main frame and movable to and from the open position allow access to the shelves when open and limiting access to the shelves when in the closed position. One door is provided for each level of the carousel leading to the shelf located behind the door. A driver is mounted on the main frame and engaged with the carousel for drivingly rotating the carousel about the axis bidirectionally and positioning a location of a shelf behind each door. In some embodiments a locking mechanism is mounted on the main frame and releasably engageable with the carousel limiting movement of the carousel. In some embodiments the locking mechanism is the braking capabilities provided by the driving mechanism, in an example, a servo-motor brake.

In some embodiments, said intermediate walls extending radially outward from said axis separating said shelves into compartments; and said carousel has a top portion adjacent to each section and a bottom portion adjacent to each section which limits access to other shelf compartments by said hand.

In some embodiments, said frame is rotatably mounted to said bottom wall about a vertical axis of rotation and extends from said bottom wall toward said top wall, said shelves are fixed together and extend around said axis being arranged in one or more levels (e.g., three levels) spaced vertically apart with said levels aligned with said doors, said main frame has downwardly slanted floors at each of said doors providing a liquid drain.

In some embodiments, said frame includes a plurality of intermediate walls forming compartments and separating said shelves apart, said intermediate walls in each compartment diverge as they extend radially outward from said axis and cooperatively center an item inserted in the compartment when the door aligned with the compartment closes and contacts the inserted item, said frame includes a projection located in each compartment limiting insertion of said item in a compartment to an upright position.

According to another aspect, there is provided a self-serve kiosk for storing and dispensing cylinders comprising: a main frame with a bottom wall, top wall and side walls defining an enclosure for storage and dispensing of cylinders; a carousel rotatably mounted atop said bottom wall about a vertical axis of rotation, said carousel having a plurality of separate shelves located around said axis on a plurality of levels located along said axis for receiving a single cylinder on each shelf; a plurality of doors hingedly mounted to said main frame and movable to and from open positions allowing access to said shelves and closed positions limiting access to said shelves, one of said doors is provided for each level leading to a shelf located behind each door; a driver mounted on said main frame and engaged with said carousel for drivingly rotating said carousel about said axis bidirectionally and position a shelf behind each door; and a locking mechanism mounted on said main frame and releasably engageable with said carousel limiting movement of said carousel; said lock provided by an electric actuator with a claw like fixture to retain the carousel, a servo motor has holding torque and/or an electromechanical brake, of said carousel as a cylinder is removed or inserted onto a shelf; said carousel has a plurality of intermediate walls extending radially outward from said axis separating said shelves apart; receive one of said intermediate walls to hold said carousel stationary, said carousel has a top portion adjacent which said hand is located to limit contact by said hand with any foreign material located at the bottom of said carousel.

In some embodiments, said carousel includes a carousel frame rotatably mounted to said bottom wall about a vertical axis of rotation and extending from said bottom wall toward said top wall, said shelves are fixed together and extend around said axis being arranged in at least one level (e.g., three levels) spaced vertically apart with said levels aligned with said doors, said main frame has downwardly slanted entrance bottom walls located beneath each of said doors providing a liquid drain.

In some embodiments, said carousel frame includes a plurality of intermediate walls forming compartments and separating said shelves apart, said intermediate walls in each compartment diverge as they extend radially outward from said axis and cooperatively center an item inserted in the compartment when the door aligned with the compartment closes and contacts the inserted item, said carousel frame includes a projection located in each compartment limiting insertion of said item in a compartment to an upright position.

In some embodiments, said carousel frame is mounted in rolling contact with a plurality of wheels, rollers, or bearings affixed to said bottom wall that support said carousel frame thereon. Said carousel frame is rotatably mounted to said top wall and extending into said bottom wall so that the carousel frame is limited for sideways movement of said carousel frame about said axis as said carousel frame rotates.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will become apparent to those skilled in the art following a reading of the following description in conjunction with the drawings.

### BRIEF DESCRIPTION OF DRAWINGS

Embodiments will be described, by way of example only, with reference to the attached figures, wherein in the figures:

FIG. 1 illustrates, in a front perspective view, an example of a dispenser, in accordance with some embodiments;

FIG. 2 illustrates, in a front perspective view, an example of a main frame of the dispenser of FIG. 1, in accordance with some embodiments;

FIG. 3 illustrates, in a front view, another example of a dispenser, in accordance with some embodiments;

FIG. 4 illustrates, in a front view, an example of the dispenser of FIG. 3 including a carousel, in accordance with some embodiments;

FIG. 5 illustrates, in a front perspective view (isometric), an example of an air vent and vent tube mounted to a top portion of the main frame of FIG. 2, in accordance with some embodiments;

FIG. 6 illustrates, in a fragmentary front view, an example of a top door and a compartment there behind, in accordance with some embodiments;

FIG. 7 illustrates, in an enlarged perspective view, an example of a door lock, in accordance with some embodiments;

FIG. 8 illustrates, in front perspective views, an example of a dispenser having five doors, in accordance with some embodiments;

FIG. 9 illustrates, in a front perspective view, an example of a rotatable carousel mounted atop the bottom floor of the dispenser of FIG. 1, in accordance with some embodiments;

FIG. 10 illustrates, in an enlarged perspective view, an example of a bottom floor of the dispenser of FIG. 1, in accordance with some embodiments;

FIG. 11 illustrates, in an enlarged perspective view, an example of a driving mechanism for rotating a carousel, in accordance with some embodiments;

FIG. 12 illustrates, in a fragmentary perspective view, an example of a distal end of the driving mechanism of FIG. 11, in accordance with some embodiments;

FIG. 13 illustrates, in a front perspective view, an example of a drive mechanism for rotating a carousel, in accordance with some embodiments;

FIG. 14 illustrates, in an alternate underside view, an example of the drive mechanism of FIG. 13, in accordance with some embodiments;

FIG. 15 illustrates, in an isolated view, an example of the driven gear of the drive mechanism of FIG. 13, in accordance with some embodiments;

FIG. 16 illustrates, in a perspective view, an example of a motor and pinion of the drive mechanism of FIG. 13, in accordance with some embodiments;

FIG. 17 illustrates an example of a belt and pulley power transmission system, in accordance with some embodiments;

FIG. 18 illustrates an example of a gearbox, in accordance with some embodiments;

FIG. 19 illustrates an example of a synchronous timing belt and large pulley attached to carousel top, in accordance with some embodiments;

FIG. 20 illustrates an example of a worm gear power transmission system, in accordance with some embodiments;

FIG. 21 illustrates an example of a chain and sprocket power transmission system, in accordance with some embodiments;

FIG. 22 illustrates an example of a direct drive power transmission system, in accordance with some embodiments;

FIG. 23 is a bottom perspective view, an example of a locking mechanism for limiting rotation of the carousel of FIG. 9, in accordance with some embodiments;

FIG. 24 illustrates, in a perspective view, an example of a brake of the drive mechanism of FIG. 13, in accordance with some embodiments;

FIG. 25 illustrates, in an electrical schematic, an example of wiring connections between a pneumatic (Inputs/Outputs) board and sensors and solenoid valves, in accordance with some embodiments;

FIG. 26 illustrates, in a flowchart, an example of a method of exchanging a cylinder in a dispenser, in accordance with some embodiments;

FIG. 27 illustrates, in a flowchart, an example of a method of purchasing a cylinder in a dispenser, in accordance with some embodiments;

FIG. 28 illustrates, in a flowchart, another example of a method of exchanging a cylinder in a dispenser, in accordance with some embodiments;

FIG. 29 illustrates, in a flowchart, another example of a method of exchanging a cylinder in a dispenser, in accordance with some embodiments;

FIG. 30 illustrates, in a flowchart, an example of a method of refilling cylinders in a dispenser, in accordance with some embodiments;

FIG. 31 illustrates, in a flowchart, an example of a method of a financial transaction process, in accordance with some embodiments;

FIG. 32 illustrates, in a flowchart, an example of a method of inventory control and preparation, in accordance with some embodiments;

FIG. 33 illustrates, in a flowchart, an example of a method of resetting a dispenser, in accordance with some embodiments;

FIG. 34 illustrates, in a flowchart, an example of an RFID process, in accordance with some embodiments;

FIG. 35 illustrates, in a flowchart, an example of a method of determining that it is save to vend, in accordance with some embodiments; and

FIG. 36 illustrates and example of a computer.

### DETAILED DESCRIPTION

Embodiments of methods, systems, and apparatus are described through reference to the drawings.

In the following description, the terms “container” and “cylinder” are used interchangeably. It should be understood that use of the term “cylinder” is to provide a descriptive example. However, this term may be substituted to refer to any “container” for flammable or hazardous substances that would meet the definition for hazardous location dispenser for compressed gases.

The following disclosure describes a compact Liquefied Petroleum Gas (LPG) cylinder (or container) dispenser that is compact while maximizing the number of cylinders stored therein. In some embodiments, the dispenser includes a rotatable carousel for dispensing containers having a locking mechanism to prevent rotation whenever a compartment door is open.

While dispensers are described herein as dispensing cylinders, it will be appreciated that embodiments disclosed herein can be configured to dispense a variety of objects, including containers propane cylinders, a package, or any object or container that may contain a hazardous product thus constituting the need for a dispenser that is suitable to dispense in a hazardous environment. The containers are suitably sized to fit the available compartment size, and can further be configured for exchange of containers of compressed gases or other hazardous material, pick up of such containers, shipment pickup (“secure pick-up” point for deliveries), and the like. The sensing and size of compartments may be modified to accommodate use of dispenser with other objects.

Embodiments as disclosed herein may conform to appropriate rules for hazardous locations, meeting hazardous environment standards (e.g., Class 1, Division 2) for dispensing items such as propane cylinders or containers for other flammable or hazardous substances that would meet the definition for hazardous location dispenser for compressed gases. Hazardous locations are areas where flammable liquids, gases or vapors or combustible dusts exist, or may exist, in sufficient quantities to produce an explosion or fire and present a risk to the safety of persons interacting within the environment. Embodiments herein may also meet other appropriate standards as published by the National Fire Protection Association (NFPA), National Electrical Code (NEC), the Canadian Electrical Code, the International Electrotechnical Commission, and other standards. Components in hazardous environments are to be non-sparking, low-power, shielded, and/or intrinsically safe (i.e., incapable of releasing sufficient electrical or thermal energy under normal or abnormal conditions to cause ignition of a specific hazardous mixture). Electrical connections are also to be compliant with hazardous environment requirements. Requirements can vary, but typically connections are able to withstand a pulling force above a certain threshold and remain stable. Such resistance is required since loose connections could cause a spark/arc. Connectors may be required have an auxiliary mechanical means to resist strain other than the wire crimp/joint into the connector itself (i.e., a bracket with a zip tie to grip the cable). Components should also be sufficiently grounded.

This unit may comply with the codes and regulations that are applicable to its use. In the propane industry one of the requirements is that in certain circumstances it must meet a hazardous environment (e.g., Class I, Division 2) electrical standard along with all jurisdictional and federal propane storage and handling codes, and other standards that may become applicable over time.

Carousel based self-serve kiosks provide many of the advantages of the locker-based alternatives, but can store a larger number of cylinders in a much smaller footprint.

Aspects of various embodiments are described through reference to the drawings. The terms “kiosk” and “dispenser” are used interchangeable in the description herein.

In some embodiments, a dispenser may comprise a frame having a series of doors, and a carousel with multiple levels (e.g., one door for each level). The carousel may be divided into sections (or compartments or bays) to house a separate cylinder. The carousel may be rotated by a mechanism (e.g., a linear actuator with a latching mechanism, a small motor (e.g., a small servo motor) mechanism, etc.) to rotate the carousel to allow access to each compartment (or section or bay) from the same door. A controller or computer may be used to control outputs and inputs via actuators and/or sensors. The controller or computer may comprise a processor and memory which to operate the dispenser. A human-machine interface (e.g., a touch screen, or a display screen with buttons, etc.) may also be included to facilitate users to exchange or purchase cylinders. The human-machine interface (HMI) may also facilitate machine owners or operators to access other machine functionality.

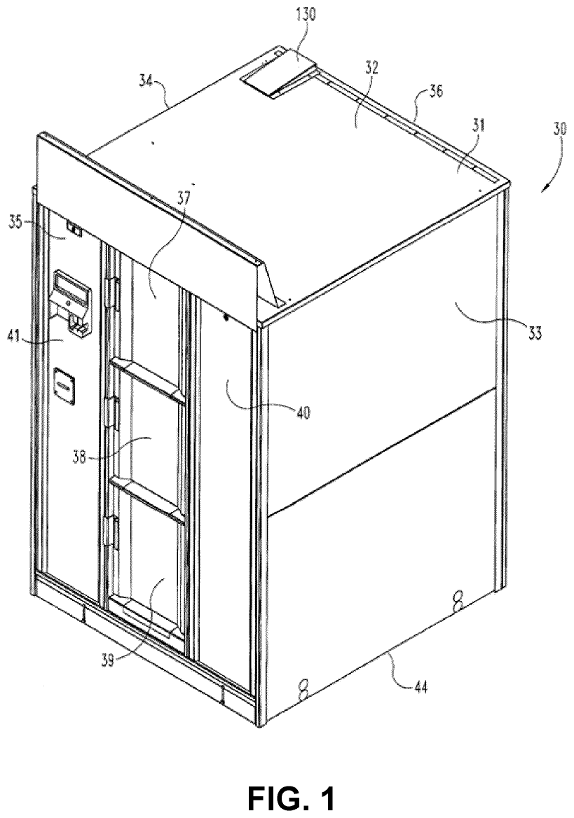

Referring now more particularly to FIG. 1, there is shown a dispenser 30 for storing and dispensing objects or containers such as liquefied petroleum (LP) tanks (for example, certified by the American Society of Mechanical Engineers (ASME)) or cylinders (for example, certified by Department of Transport (DOT)), in accordance with some embodiments. Dispenser 30 can be configured as a six-sided cabinet 31 enclosing containers to be stored and dispensed.

In some embodiments, there are other configurations of the dispenser, such as other sizes/shapes of cabinet 31.

Dispenser 30 can be configured to store objects such as cylinders arranged in rows (or levels) extending both horizontally and vertically. A plurality of doors are arranged horizontally and vertically with a separate door assigned for each cylinder compartment (or section) for insertion of an empty cylinder or removal of a full cylinder. In some embodiments, each row (or level) will have one corresponding door. In other embodiments, each row may have multiple doors on different sides of the dispenser. For ease of discussion, the embodiment with only one door associated with each level will be described.

The doors are releasably opened by locks (e.g. electromechanical door locks). Access may be granted to a particular container by utilizing keys. In some embodiments, keys can be physical, digital or other suitable keys. Inductive proximity sensors and floor sensors can be used to indicate whether a cylinder is absent from the particular compartment or whether a filled or unfilled cylinder is present. Such proximity sensors may detect metal, which is commonly used to make LPG cylinders. The sensors may be positioned strategically to make use of one sensor per level where the carousel may rotate around the sensor, or one sensor per carousel. Alternatively, the sensors may be capacitive, ultrasonic, laser, optic or other proximity-type.

In some embodiments, various techniques for stocking compartments (or sections or bays) can be utilized, in addition or alternative to each compartment manually stocked by a person.

Cabinet 31 includes a roof (i.e., top wall) 32 mounted to a pair of side walls 33 and 34 along with a front wall 35 and rear wall 36. Walls 33, 34, 35 and 36, in turn, are mounted atop a bottom wall (i.e., floor, base or platform) 44. The cabinet provides enclosure for other components in the dispenser 30, and protects against unauthorized access to items (e.g., cylinders) stored in the dispenser 30. In some embodiments, mounting points may be added to mount the dispenser 30 to the ground.

It should be noted that throughout this description, reference is made to “walls”. The term “walls” may include a fixed wall, a mesh, an expanded material, or any barrier that will secure the containers within the dispensing structure.

Front wall 35 has a number of doors pivotally and hingedly mounted to allow access to compartments within the cabinet. In the embodiment shown in FIG. 1, the doors consist of a top door 37, middle door 38 and bottom door 39 arranged in a vertical row. Doors 37, 38 and 39 may be opened and closed to store an empty container provided by the consumer and/or to provide a full container for withdrawal from the cabinet.

In some embodiments, there may be other positions/configurations of doors for accessing the cabinet. For example, each side of the frame may comprise a door corresponding to a compartment. Alternatively, the frame may be cylindrical or have additional sides with associated doors.

A service door 40 may be mounted to the cabinet and pivot open and closed on a hinge and may be opened by service personnel.

A control door 41 may also be mounted to the dispenser and pivot open and closed on a hinge and may be opened by service personnel for servicing the electronics.

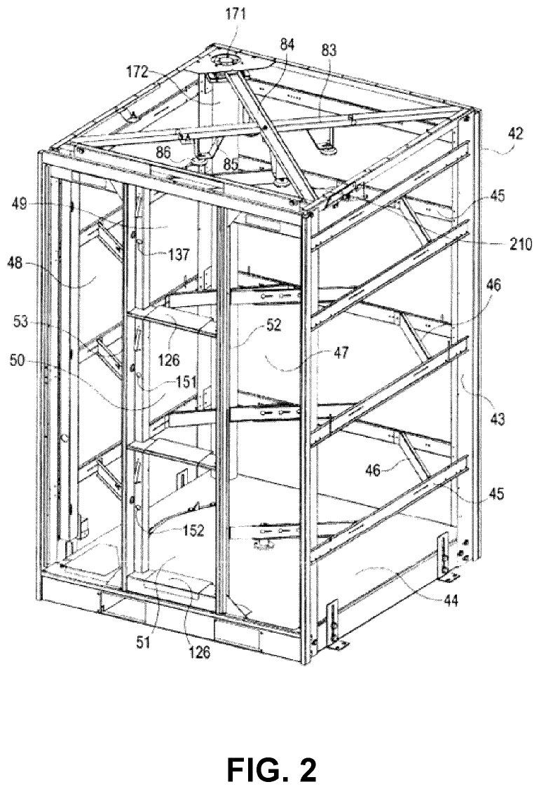

FIG. 2 illustrates a main frame 42 of dispenser 30, in accordance with some embodiments.

In some embodiments, main frame 42 provides a frame for dispenser 30 that is rigid and stable. The frame may be structurally sound—for example, due to the inclusion of diagonal braces 46. In some embodiments, there are other ways that dispenser 30 can be secured, and in particular in a way that has advantages, such as saving space, and may use cheaper/lighter materials.

Main frame 42 includes a plurality of vertical members 43 mounted to and extending upwardly from the bottom wall 44. A plurality of horizontal cross members 45 have opposite ends secured to vertical members 43 on the two sides and rear of the back of the main frame. In addition, a plurality of diagonal braces 46 have opposite ends secured to members 45 increasing the rigidity of the frame. These cross braces could serve the additional function of retaining containers within said carousel during rotation and serve a means of theft prevention of product stored behind said retaining brace. The front of the frame includes a pair of vertically extending openings 48 and 47 that are closed by doors 40 and 41. In some embodiments, the compartments may be angled outwards to encourage water runoff outside the machine to protect mechanical and electrical components.

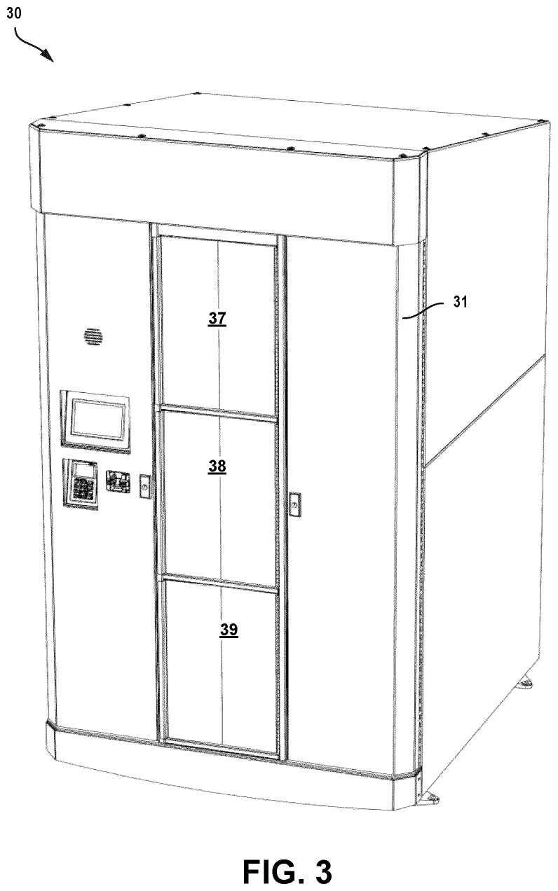

In some embodiments, for example, as shown in FIG. 3, a frame design incorporates the side(s) and back panels to create a solid structure instead of a frame. The two side front doors may still be present for maintenance access. There may or may not be corner bracing. At the top is a diagonal cross member that help provide rigidity and is used to mount the new carousel drive servo motor.

Further, three openings 49, 50 and 51 are located between openings 47 and 48 with openings 49-51 being aligned with doors 37-39 to allow access to the carousel compartments located behind the openings. A pair of vertical members 52 and 53 located on the opposite sides of openings 49-51 to separate openings 49-51 from the side openings 47 and 48. Members 52 and 53 are connected to the top and bottom of the frame 42. In some embodiments, an access panel is located on the lower rear of the back panel to provide maintenance access to the lower back portion of the dispenser.

In some embodiments, one or more door opening 49-51 includes a slanted entrance bottom wall located beneath each door and leading to the carousel shelf. For example, wall 126 slants in a downward direction as the wall extends outwardly thereby providing an automatic liquid drain (e.g., a redundant water runoff) to prevent ice build-up between the wall and the closed door.

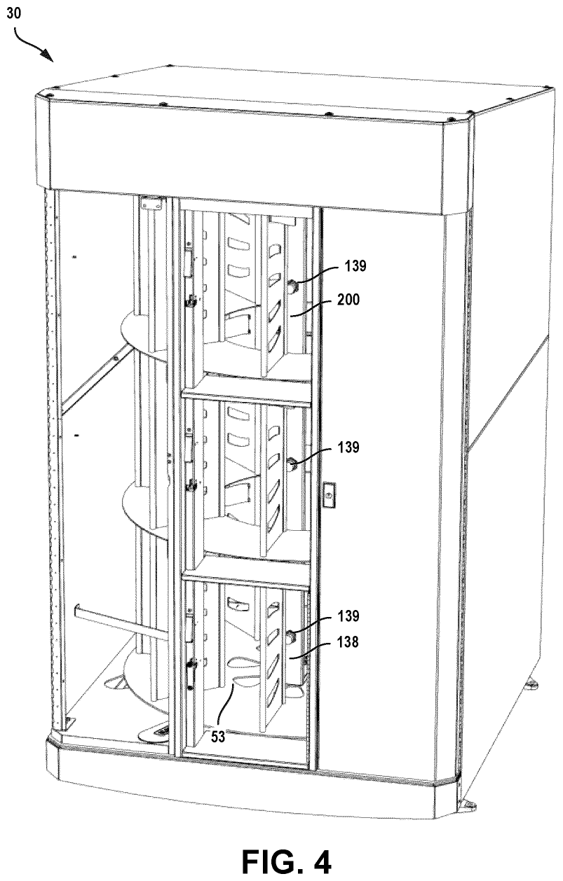

FIG. 3 is a front view of a dispenser 30 enclosed in a cabinet 31, in accordance with some embodiments, and may be generally similar in structure and components to dispenser 30 illustrated in FIG. 1. FIG. 4 illustrates, in a front view, and example of dispenser 30 of FIG. 3 including a carousel 53, in accordance with some embodiments.

The structure 30 comprises a rigid frame mounted on a base. In some embodiments, the rigid structure fastened to the base is comprised of four panels that form the sides of the unit, and two panels that form the back of the unit. The panels may be constructed from a metal or composite material. The panels are bolted together to form the external sides and back of the kiosk. The fasteners that can be used to secure the structure of the kiosk are designed to be tamper resistant to avoid theft from within the kiosk. Cross members are located strategically to help support both the side and back panels internally. The side and rear panels that make up part of the structure of the enclosure may be either solid or contain holes or slots to allow for a higher frequency of air exchanges and increased ventilation. Mounted to the front of the kiosk is a front frame consisting of three propane cylinder access doors and two side service doors. The frame is fastened to the sides to form the four-sided kiosk and provide rigidity to the structure. The front frame may be constructed from a metal or composite material. At the top of the kiosk, an internal cross member is installed to help with rigidity but also provide a mounting location for the electric servo motor and a centre-mounted bearing for the carousel. A roof is fastened to the top of the upper side panels and provides structural integrity to the kiosk and protection from the elements. In some embodiments, the roof may be sloped to provide redundant water runoff.

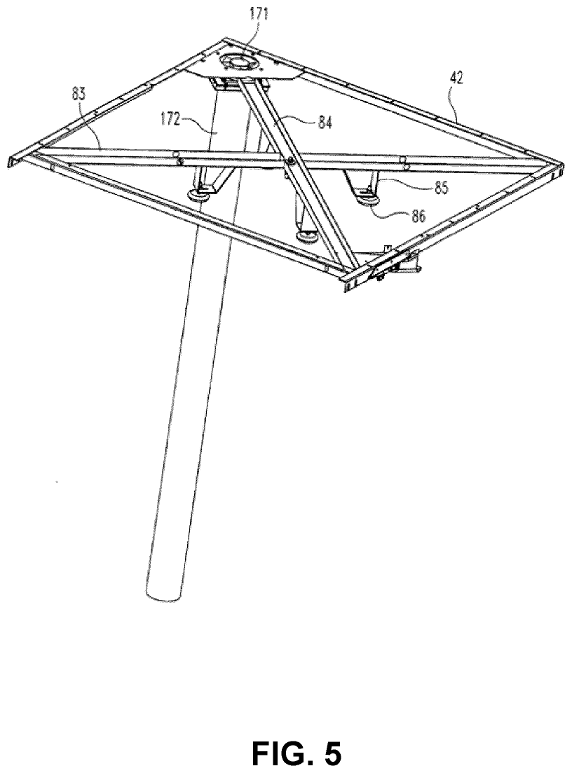

Also located on the rear of the kiosk structure is an exhaust vent that is provided on the top rear panel of the kiosk. As shown in FIG. 5, in some embodiments an exhaust vent 130 is provided on the top wall 32 or top rear wall of cabinet 31. An exhaust fan 171 can be connected to the vent (e.g., mounted directly beneath vent 130 to main frame 42) and has an intake tube 172 that extends downward through the length of the cabinet to the base of the kiosk. The tube may have holes or vents formed therein to allow evacuation of gas and vapors from various levels within the enclosure out through vent 130. Appropriate sensors (not shown) may be located at various positions within the enclosure or cabinet 31 to sense the presence of gases or vapors and to activate exhaust fan 171 (position dependant on the characteristics of the LPG in the cylinders—e.g. propane is heavier than air so the sensor and duct would be located at the bottom of the enclosure). Those sensors can be utilized to activate the exhaust fan through a software interface. It should be noted that exhaust fan 171 is designed to be compliant with any hazardous environment standard (e.g., Class 1, Division 2).

Gas sensors (e.g., hydrocarbon sensors) are located in a position within the dispenser that is suitable for their type and purpose. Specific circumstances sensed by the gas sensors can trigger the exhaust fan and result in subsequent venting.

In some embodiments, gas detection sensors are located in a suitable position in dispenser 30, which can be suitable types of gas detection sensors. Specific circumstances sensed by the gas sensors can trigger vent exhaust. Given each compartment being relatively contained (having separating walls, etc.), a buildup of gases/temperature may be a risk in a single compartment, and sensed and vented and extinguished suitably. The input of the gas detection sensor can offer the ability to partially or completely decommission the dispenser to protect the public and notify the owner of the dispenser regarding its condition or state.

As shown in FIG. 3, the structure of the front frame has a number of doors that pivot on a pin-style or seamless hinge to allow access to compartments within the kiosk enclosure. It should be noted that the dispensing structure (i.e., kiosk) may have 1 or more doors. The propane doors (or compartment doors) consist of a top door 37, middle door 38, and bottom door 39 arranged in a vertical configuration on top of one another in the center of the kiosk. It should be understood that other embodiments may have the doors aligned differently. Propane doors may be opened and closed to store an empty container provided by the consumer and/or to provide a full container for withdrawal from the cabinet. In some embodiments, a right-side service door 40 is mounted to the kiosk and may be opened by service personnel. In some embodiments, a left side control door 41 is also mounted to the kiosk and may be opened by service personnel. The front frame propane doors located in the middle of the front panel open to allow access to the carousel compartments located behind the openings.

The front frame propane door openings include a slanted entrance bottom shelf located beneath each door that leads to the carousel shelf. The shelf slants in a downward direction as the shelf extends outwardly thereby providing an automatic liquid drain to prevent ice build-up between the shelf and the closed door. Each door and compartment combination include a door sensor, which senses the nature of whether the door is open or closed, a cylinder sensor, which senses whether a propane cylinder is present or not, an electromechanically operated door lock with a redundant open or closed sensor, LED lighting for illuminating the compartment, and a spring mechanism that promotes the door to pop open once unlocked.

One door or compartment will be described however it should be understood that an identical description can apply to the remaining doors and their associated compartments. The propane door has a vertically extending proximal edge portion and is hinged to the main frame of the kiosk enclosure. Mounted and fastened on the propane door is a latch. The vertically extending distal edge portion of the front frame includes a mounted electromechanical door lock and a latch the mates with the lock. When the propane door is closed, the aligned door latch and lock mechanically latches to the lock compressing the spring. Therefore, when the door lock is activated, it releases the latch and allows the spring to force the door to the open position. The spring is mounted to the wall surrounding the front of compartment. In some embodiments, door locks may include a manual override lever (accessible by opening service doors) which allows doors to open and close manually in the event of a power outage or other conditions which prevent the dispenser 30 from operating automatically.

In some embodiments, other door locks may be utilized, and may be actuated using an electromechanical mechanism and/or pneumatic mechanism.

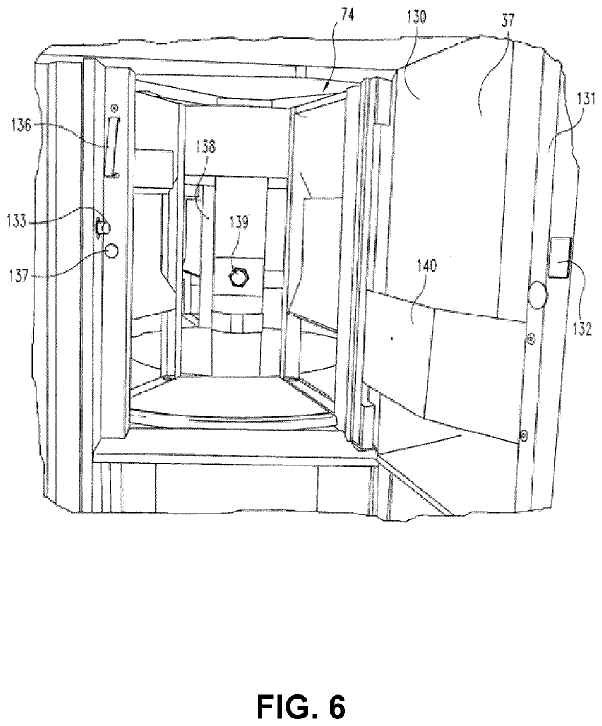

Each door 37, 38, 39 and compartment combination includes a door sensor, a cylinder sensor, a pneumatically or electromechanically operated door lock, and a spring for popping the door open once unlocked. FIG. 6 illustrates door 37 of compartment 74, and will now be described being understood that an identical description can apply to the remaining two doors 38 and 39 and their associated compartments. As shown in FIG. 6, door 37 has a vertically extending proximal edge portion 131 and is hingedly mounted to the main frame of the dispenser allowing a spring 136, such as a leaf spring, to force the door to the open position.

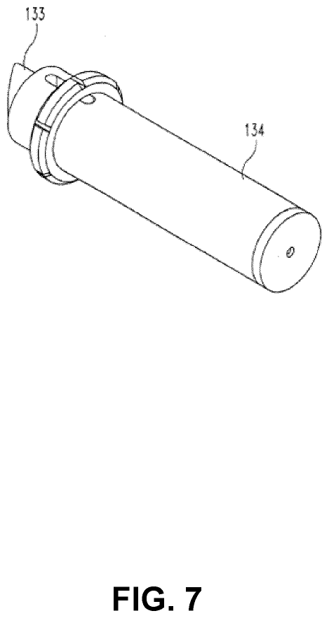

In some embodiments, the vertically extending distal edge portion 131 includes an opening 132 into which a distal end 133 of a piston rod associated with a pneumatic, gas or electromechanical cylinder 134 projects. Cylinder 134 and distal end 133 are illustrated in FIG. 7. Cylinder 134 is mounted to the dispenser main frame and includes an extendable piston rod which projects outwardly into opening 132 locking the door in the closed condition. Once gas pressure is applied to cylinder 134, the piston rod is caused to retract moving distal end 133 apart from the door and allowing spring 136 to force the door to the open position.

In some embodiments, instead of the compressed gas powered cylinder (piston) locks shown in FIG. 7, electromechanical door locks/latches can be used. These electromechanical door locks are solenoid actuated cam latches, and are controlled by an electrical signal originating at the microprocessor (likely going through a solid state relay in the process). These latches can include an embedded limit switch or other sensor to determine whether the latch is open or closed. This switch/sensor can be used on its own, or in combination with another sensor that is setup to detect whether the door is open or closed.

Spring 136 can be mounted to the wall surrounding the front of compartment 74. A separate cylinder 134 is provided for each of doors 38 and 39.

In some embodiments, for opening the compartment door a electromechanical lock assembly and door mounted latch will be used and be controlled by the on-board processor or computer.

A door sensor 137 is mounted to the same wall having spring 136 mounted thereto and is depressed with the door is in the closed position. Separate sensors 151 and 152 are used to detect whether doors 38 and 39 are closed or opened and whether a cylinder is located within the associated compartment.

When the door sensor is activated (door closed) the circuit allows the electrical current to flow to the controller or microprocessor which processes the input signal. If the current flow is interrupted, that is, when the door is open; the controller or microprocessor sends and output signal (electrical current) to turn on the LED Light and stay on until the door is closed.

In some embodiments, a door sensor is mounted to the front frame assembly that also houses the spring mounted thereto and is depressed with the door when it is in the closed position.

Door sensors such as door sensors 137 can be any suitable type of door sensor, and sense door open and/or closed, precise door positions, and other. Other information can be determined such as time stamp on when the door is open and/or closed, and may be combined with other events for example when a service door is opened and closed and linked to identifying information of an individual who opened the door. Door sensors could also be used on the front left and right service door and other doors or hinged service covers. Service door interlock sensors may also detect whether the service doors are open or closed. Such input may be used to prevent the carousel from moving while service doors are open.

In some embodiments, other kinds of sensors may be used to detect whether a cylinder is present in a compartment, and/or whether the cylinder is full or not. For example, piezoelectric sensor in floor pressure to estimate weight (and hence fullness) of the cylinder.

Returning to FIG. 4, in some embodiments, dispenser 30 includes a sensor tower 200 having a vertical rack 138 fixedly mounted to the bottom base of the enclosure and includes multiple sensors 139 to detect, when activated, the presence of a cylinder within the compartment. The sensor may be a proximity type of sensor or any type of sensor that accomplishes this need. The “tank pusher” described earlier on is mounted to the propane doors and projects inwardly when the door is closed to engage the cylinder within the compartment and force the cylinder rearward to activate the sensor. When the door is opened and the tank or cylinder is removed, the sensor then detects the absence of a tank or cylinder within the compartment.

In some instances, other appropriate sensors may be included, for example, a level sensor (e.g., a level sensor such as a gas or liquid level sensor such as a propane level sensor) to detect whether a cylinder is full or empty. These types of sensors could be ultra sonic, infrared, or any other suitable type of sensor. For example, a contactless sensor, attached beside (or in place of) a proximity sensor, detects whether cylinder is empty or full. The contactless sensor can also be used in place of a proximity sensor as it determines presence or lack thereof of a cylinder. The level sensor (e.g., propane level sensor) may also by used for inventory determination. The carousel may be rotated while sensors read to determine whether each cylinder is empty or full.

In some embodiments, tank sensors detect when a cylinder has been placed inside a compartment. A separate sensor is provided for each compartment. When the cylinder is inside the compartment, it changes the electrical circuit allowing the controller or microprocessor to see an input for each individual compartment.

As shown in FIG. 6, a vertical rack 138 can be fixedly mounted to the bottom pin which in turn is mounted to the bottom wall of the dispenser and includes a multiple of commercially available cylinder sensor 139 to detect when activated the presence of a cylinder or a cylinder within the forward facing compartment. Sensor 139 may be a proximity type of sensor or any type of sensor. A protruding wall 140 is mounted to the door 37 and projects inwardly when the door is closed to engage the cylinder within the compartment and force the cylinder rearward to activate sensor 139. When the door is opened and the cylinder is removed, the sensor 139 then detects the absence of a cylinder within the compartment.

In some embodiments, other appropriate sensors may be included, for example, temperature sensors to detect if too much heat builds up, accelerometer to detect damage to dispenser by a bad actor trying to access the dispenser, or areas in risk of earthquakes, a sensor to detect gas pressure build up.

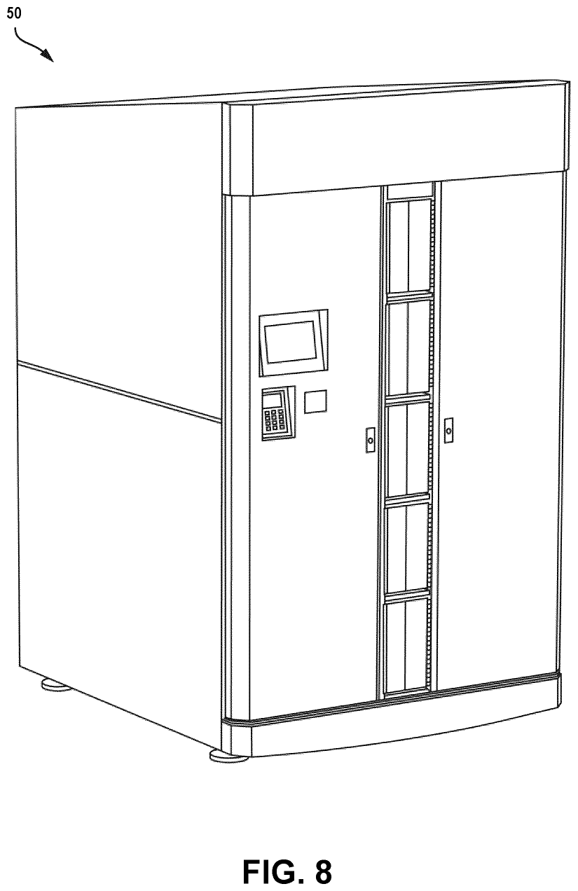

Three doors are shown in FIG. 3. However, there may be designs with fewer or more doors. For example, FIG. 8 illustrates, in front perspective views, an example of a dispenser 50 having five doors, in accordance with some embodiments. The example shown in FIG. 8 may be used for smaller (e.g., one pound) cylinders, while the example shown in FIG. 3 may be used for larger cylinders (e.g., 20 pound BBQ sized cylinders). The dispenser 50 has five levels in its carousel and five corresponding doors. Dispensers having other number of carousels and doors may be designed. The inner workings of the dispensers 30, 50 are similar and are described below with reference to dispenser 30.

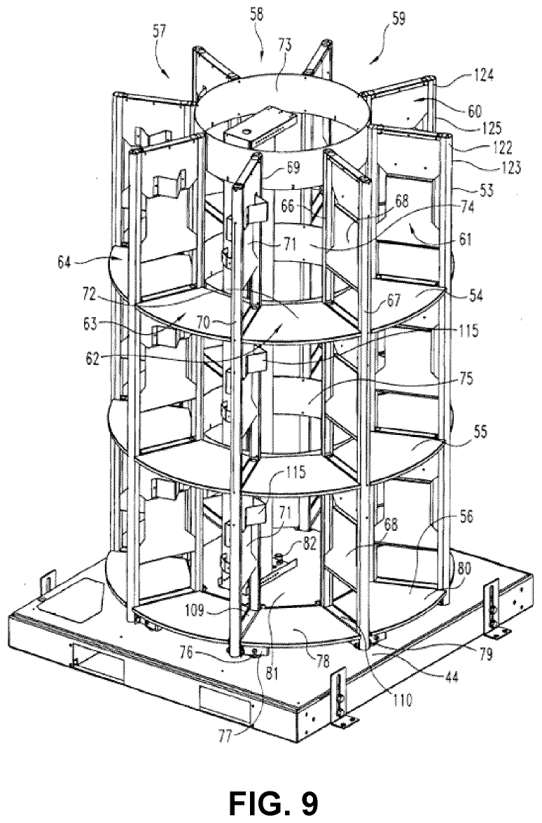

FIG. 9 illustrates, in a perspective view, an example of a carousel 53 mounted atop the bottom floor of dispenser 30, in accordance with some embodiments.

In some embodiments, other configurations of carousels or frame for conveying cylinders include carousel rotating about a different axis (instead of a vertical axis). In some embodiments, carousel can move linearly. In some embodiments, a carousel can move in a similar manner to a conveyor belt (moves linearly across the top of the belt, drops down, and returns along the bottom). Conveniently, using a rotatable carousel may allow for compactness. In some embodiments, compartments are in different positions on the carousel. In an example, the carousel can include three rows of eight compartments in each row. Each compartment may be wider (e.g., twice as wide) as that shown in FIG. 9, for example, to dispense differently sized objects. In some embodiments, compartments on a carousel level may have the same size, while in other embodiments, the compartments on a carousel level may be sized differently.

Carousel 53 is rotatably mounted atop bottom wall 44 and has three shelf levels 54, 55 and 56 that are aligned respectively with openings 49, 50 and 51 as the carousel is rotated. Each shelf level 54-56 is divided into eight separate compartments although a greater number or lesser number of compartments may be provided. The compartments are formed by vertically extending members. For example, shelf level 54 has eight compartments 57-64. In some embodiments, each compartment has an identical design.

Compartment 62 will now be described it being understood that an identical description may apply to compartments 57-61, 63 and 64. Compartment 62 is formed on its right side by vertical members 66 and 67 horizontally spaced apart and joined together by a plurality of walls 68. Likewise, a second pair of vertical members 69 and 70 are spaced apart and joined together by walls 71. The bottom wall 72 of compartment 62 has its sides connected to dividers (such as vertical members 66, 67, 69 and 70) and provides the shelf upon which the LPG cylinder or container or other object rests. Each compartment is wedge shaped with the outside of the dividers (such as outer members 67 and 70) being spaced apart a distance greater than the horizontal spacing between insides of the divider (such as inner vertical member 66 and 69).

A plurality of ring shaped walls are provided inwardly of each compartment and are attached to the inner vertical members to provide rigidity of carousel 53. For example, ring shaped wall 73 is located at the top of carousel 53 and is positioned immediately inward of and attached to the inwardly located vertically extending members forming each compartment. For example, vertical members 66 and 69 are located outwardly of and attached to ring shaped wall 73. Likewise, a middle ring shaped wall 74 and bottom ring shaped wall 75 are at the top portion of shelf levels 55 and 56 and are located inwardly of and attached to the inwardly located and vertically extending members forming each compartment.

The compartments are designed to center the cylinder or container within the compartment. Typically, an LPG cylinder has a relatively small top end which is formed by the cylinder valve whereas the bottom end of the cylinder is relatively large and round. Thus, a centering bracket 115, as shown in FIG. 9, is fixedly mounted to one of the side walls forming each compartment so that the distance between side walls is reduced. The size of the centering bracket 115 is selected to prevent an LPG cylinder from being inserted upside down and requiring the cylinder to be inserted right side up with the reduced top valve end located at the top of the compartment. Likewise, since each compartment is wedge shaped, the cylinders are automatically centered as they are pushed into the compartment. The shape of centering brackets may be specifically designed to prevent a LPG Cylinder from being placed in the compartment upside down. In some embodiments, a bracket may be attached to a door to ensure that an inserted cylinder is forced into a consistent position on the carousel when the door is closed. For example, if a cylinder is placed on the carousel but not all the way in the correct position, as the door is closed, this bracket pushes the cylinder into the proper position (the door cannot be closed until the cylinder is in the correct position). This ensures that any cylinder sensor in consistent in sensing whether or not the cylinder is present.

The entire carousel 53 rides on a plurality of wheels or rollers located beneath and mounted to the carousel. For example, roller 76 is rotatably mounted to an L-shaped bracket 77 fixed to vertical member 70 and member 109 beneath bottom wall 78. Likewise, roller 79 is rotatably mounted to an L-shaped bracket fixedly mounted to vertical member 67 immediately beneath bottom shelf wall 80 of level 56. An additional pair of wheels may be rotatably mounted to L-shaped brackets fixedly secured to inwardly located vertical members 69, 109 and 66 located respectively beneath bottom shelf walls 78 and 80. In a similar fashion, wheels are rotatably mounted by L-shaped brackets to each vertical member forming the eight compartments for each level and are located on the outward side of each compartment and may be located on the inward side of each compartment allowing the carousel to rotate about a vertical axis atop bottom wall 44.

In some embodiments, a plurality of wheels mounted to the base using U-Shaped brackets. Another embodiment could be multiple ball transfer bearings strategically positioned in the base to support the carousel while rotating about the vertical axis.

It can be appreciated that arranging LPG cylinders in horizontal rows requires considerable space for the cabinet or vending machine. There is therefore a need for a more compact cylinder dispenser. Conveniently, compactness may be achieved by utilizing a rotatable carousel 53 as disclosed herein.

The carousel 53 shown in FIG. 9 is comprised of three shelf or compartment levels. Each level is supported by vertically mounted rigid dividers that create eight individual pie shaped compartments on each level for storing of the propane cylinders. (Note: it is a consideration that the diameter of the carousel could be increased or decreased to facilitate more or less pie-shaped compartments). The compartments are designed to center the cylinder or container within the compartment and contain the inventory within the rotational envelope of the kiosk carousel. Typically, a propane cylinder has a relatively small top end which is formed by the cylinder valve guarding, whereas the bottom end of the cylinder is relatively large and round to provide stability when sitting on a flat surface. Likewise, since each compartment is wedge shaped, the cylinders are automatically centered as they are pushed into the compartment. A mechanism exists on the propane door of the kiosk/dispenser to push the cylinder back into place within the rotational envelope of the kiosk/dispenser.

Each divider is formed to incorporate a tube-like pocket that runs the vertical length of the divider. The top and bottom sides of the divider have tabs that's are formed to assist with proper location and assembly on the levels. The dividers are mounted to each level using the locating tabs that fit into slots located on the shelf. Hollow pins are inserted inside the tube-like pocket to provide the support on both edges of the divider. The carousel is held together with a threaded rod that is installed from the top of the carousel plate and through the hollow pins threading into locking nuts mounted on the under-side of the bottom carousel level. Affixed to the top side of the top carousel plate are geared segments that are fastened in a pattern to mesh with the driving gear of the servo motor, which will be discussed further in some embodiments below.

The carousel is mounted to a spindle that is mounted to the base of the kiosk. The spindle extends through a bearing that is center-mounted to the underside of the carousel bottom plate. The top of the carousel is mounted to a spindle that is mounted on the underside of the kiosk cross member support. The spindle extends through a bearing that is centre mounted to the carousel top plate. The spindle and bearing assembly allow the carousel to rotate about a vertical axis bidirectionally. Also located on the base that are designed to support the carousel and the propane cylinders are multiple transfer bearings that support the rotating carousel.

Affixed to each carousel divider is a specifically designed bracket that prevents customers from inserting a cylinder upside down in the carousel and closing the propane door. A cylinder stored upside down is a safety hazard and is not permitted in most jurisdictions. The kiosk is specifically design not to operate with such a hazard present as the obstruction prevents the propane door from closing on a cylinder that is placed in this orientation. Our kiosk therefore will not complete the customer transaction when improperly filled.

In some embodiments, the compartments can be formed by one complete divider 68 located in position by tabs and pins on both sides of the compartment. In some embodiments, carousel rings 73, 74, 75 are no longer used.

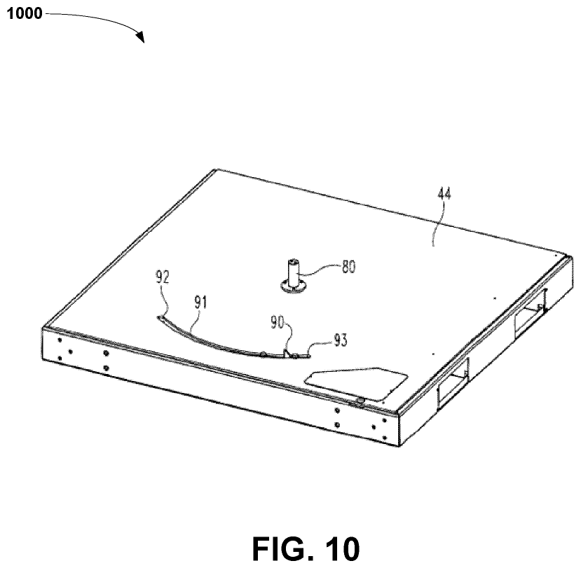

Carousel 53 is rotatably mounted to a spindle 80, shown in FIG. 10, mounted to bottom wall 44 and extending there above. Spindle 80 extends through bearing 82, shown in FIG. 9, fixed to center bottom wall 81 of the carousel. The spindle and bearing allow the carousel to rotate about a vertical axis extending centrally through bearing 82 and spindle 80.

In some embodiments, the top of carousel 53 is guided by a plurality of center ring wheels extending down from atop the main frame into and contacting the inner surface of the top ring shaped wall 73, shown in FIG. 9. The top of the main frame has a pair of diagonal braces 83 and 84, shown in FIG. 5, connected together at their central portion with the opposite ends of the diagonal braces attached to the main frame. Upwardly formed U-shaped brackets 85 have their opposite ends attached to members 83 and 84 with center ring wheels 86 rotatably mounted to the bottom end portion of brackets 85. Wheels 86 keep the carousel centered about its vertical axis of rotation. A pair of brackets 85 are mounted to diagonal cross member 83 and a second pair of brackets 85 are mounted to diagonal cross member 84. Roller wheels 86 are spaced apart radially outward from the inner portion of braces 83 and 84 to continuously contact the inwardly facing surface of top ring shaped member 73 thereby guiding the top end of the carousel as it is rotated about the vertical axis extending through spindle 80.

In some embodiments, the top of the carousel is the same as the bottom. A spindle downward mounted to a center support goes thru a bearing (similar to the one on the bottom plate) that is mounted to the underside of the top plate (gear).

FIG. 10 illustrates, in a perspective view, an example of a bottom floor 1000 of a dispenser, in accordance with some embodiments.

In some embodiments, carousel 53 is rotatably mounted to a bearing turntable, as shown in FIG. 9, mounted to bottom wall 44, and fixed to bottom wall 81 of the carousel. The bearings used at the top and bottom of the carousel could be the same or vary. Different styles of bearings could also be used.

In some embodiments, a sealed bearing is incorporated at the bottom of the carousel as well as at the top to limit side-to-side motion and the bearing construct at the bottom may eliminate the need for the wheels. There also maybe other roller type bearings, three or more mounted in the base to help support the bottom bearing while the carousel is rotating.

In some embodiments, a drive mechanism (i.e., power transmission system) for rotating carousel 53 is a cylinder 102, which can be pneumatic or gas, or electromechanical, having a piston rod attached to a spring loaded finger 90 projecting through a curved slot 91 formed in the bottom wall 44 of the main frame, as shown in FIG. 10. The terms “drive mechanism” and “power transmission system” are used interchangeable in the description herein. The length of slot 91 between its opposite ends 92 and 93 corresponds to rotating the carousel ⅛ of a turn or 45 degrees about the vertical axis of rotation for the carousel. Thus, the eight compartments for each level of the carousel are sequentially aligned with the compartments behind doors 37-39.

In some embodiments, the drive mechanism is constructed from non-sparking materials (e.g. bronze) as required in a hazardous environment.

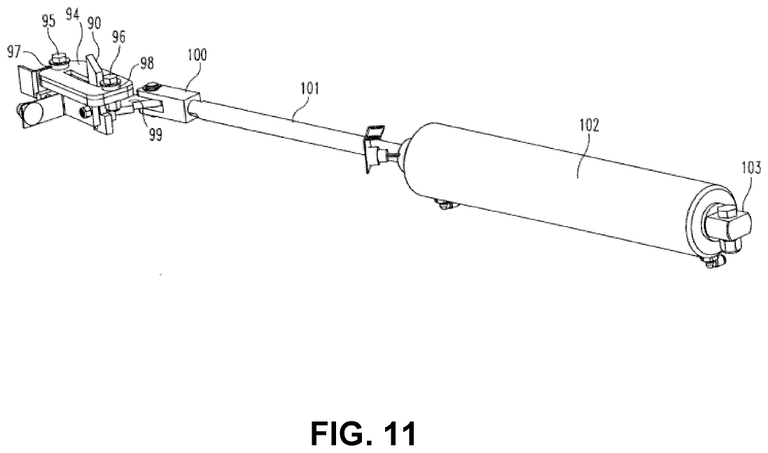

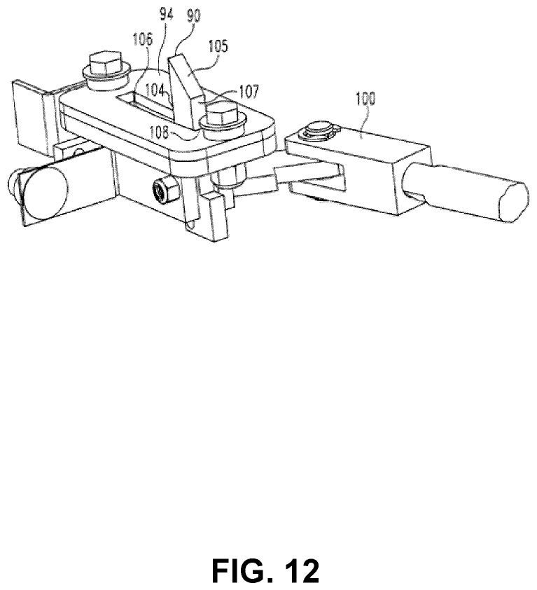

As shown in FIGS. 11 and 12, a carrier 94 is mounted beneath bottom wall 44 and includes a pair of studs 95 and 96 extending through the bottom wall slot 91. A groove 97 and 98 formed by studs 95 and 96 provide a bearing surface as carrier 94 moves the length of the slot with the head of each stud having an enlarged portion immediately above grooves 97 and 98 to keep the carrier engaged with the bottom wall. Carrier 94 is pivotally mounted by arm 99 to the bifurcated distal end 100 of piston rod 101, in turn, moved back and forth by cylinder 102. Cylinder 102 is operable to force extension and retraction of piston rod 101 to move finger 90 back and forth in slot 91. Proximal end 103 of cylinder 102 is connected to the main frame of the dispenser.

In some embodiments, the piston rod 101 and the cylinder 102 may be gas powered or powered by an electromechanical linear actuator which connects the rest of the assembly in a similar manner as the gas powered cylinder/piston. In some embodiments, instead of a sensor attached to the subassembly, the electromechanical linear actuator can have embedded limit switches installed in the housing, which detect when the linear actuator is fully extended or fully retracted. Thus, eliminating the need for the sensor.

Finger 90 releasably engages the bottom portion of the carousel. Finger 90 is pivotally mounted to carrier 94 and has a vertical surface 104 in contact with carousel 53 as the piston rod extends thereby rotating the carousel ⅛ of a turn as the finger moves from slot end 93 towards slot end 92. Once carousel 53 has been rotated the appropriate amount, the piston rod retracts with beveled surface 105 contacting the bottom of the carousel thereby causing the finger to pivot downwardly in slot 106 of carrier 94 disengaging the carousel and allowing the finger to return to slot end 93 without corresponding movement of the carousel.

Beveled surface 105 terminates at vertical finger surface 107 in contact with slot edge 108 thereby holding the finger vertically upright as the finger is then extended for an additional carousel rotation.

Extending between the bottom ends of the outward vertical members and the inwardly located vertical members forming the compartments is a contact member that extends beneath the carousel to be engaged by the spring loaded finger 90. For example, contact member 109 (shown in FIG. 9) has its opposite ends fixedly attached to outward vertical member 70 and inwardly located vertical member 69. Contact member 109 or another member attached thereto extends beneath shelf wall 78 and is engaged by the vertically extending surface 104 (shown in FIG. 12) of finger 90. The finger upon extension of piston rod 101 (shown in FIG. 12) contacts member 109 as the finger moves from slot end 93 to slot end 92. Upon retraction of the piston rod, finger 90 moves in a reverse direction toward slot end 93 with beveled surface 105 contacting the contact member 110 (shown in FIG. 9) extending between vertical members 66 and 67 with finger 90 then being forced downwardly into carrier slot 106 until the finger is on the opposite side of member 110 thereby being ready for the next carousel rotation. Instead of having finger 90 contacting members 109 and 110 any projection beneath the shelf may be utilized to cause rotation.

Finger 90 rotates the carousel in a clockwise direction as viewed in FIG. 10. Once the finger 90 has reached the end of the slot, three (vertically aligned) cylinder compartments are appropriately aligned with the three doors 37-39.

The drive mechanism for rotating the carousel includes an electric servo motor and a gear set, including at least a driving gear and a driven gear to drive carousel and rotate carousel clockwise or counter clockwise about a vertical axis. The driving gear is rotatably coupled with the electric servo motor. The driving gear can be very small relative to the driven gear, providing a mechanical advantage of, for example, 40:1. Such a mechanical advantage can allow for the use of a relatively small electric servo motor to drive a heavy carousel, as the torque output by electric servo motor is multiplied by 40 due to the gear ratio, per the 40:1 example above.

Electric servo motors offer high torque and very high positional accuracy, as well as other features such as torque controls, velocity controls, adjustable acceleration and deceleration to reduce stress and vibration, and electromechanical braking capabilities.

The driving gear meshes with a driven gear. The driven gear can be integral with carousel or affixed to the carousel in gear tooth segments, with, for example, a nut and bolt or other suitable fastener, and can provide further mechanical structure to carousel as both a structural component and as a part of drive mechanism.

Electric servo motors can be used to rotate the carousel. An electric servo motor includes an encoder to provide both position and speed feedback. Electric servo motors can use such position feedback to control its motion and final position, forming a closed loop feedback system. Such a closed loop feedback system can be configured to determine whether the electric servo motor is doing what it was commanded to do. For example, if the electric servo motor is a little bit off (in terms of commanded position, torque, velocity, or other driving programming parameter), then the electric servo motor can automatically correct itself. This process can happen multiple times per second, which may provide accurate and reliable motor performance. Encoders can determine where the electric servo motor is positionally and can generate an error if the electric servo motor is unable to physically do what it is commanded to do. In some cases, the kiosk controller or microprocessor could send the error based on the encoder commanded position and current position. Encoders of electric servo motors can detect positional and rotational information related to electric servo motor, from which positional and rotational information of the carousel can be inferred, at any time, even when the carousel is in between stationary positions. A rotational position can be measured in degrees relative to a reference “home” position.

A rotational position of the carousel can be rotated to a reference, “zero” or “home” position of a fixed point on the carousel relative to a fixed point on main frame, using a single “homing” switch. The “home” position can be designated as position “1” in an “8” position carousel. The carousel homing switch can be a contactless sensor, such as an inductive proximity sensor, or other suitable sensor (including contact switches such as limit switches), affixed to the carousel and main frame to detect when the carousel is in a designated “home” position. The switch can be hardwired and/or software connected to the controller and/or microprocessor.

An electric servo motor may be selected and programmed to have suitable velocity, acceleration and deceleration curves based on load requirements of carousel. Torque limits can be set using software of electric servo motor or programmed using the controller or computer to prevent electric servo motor from driving into an unexpected obstruction or “jamming” on something. The kiosk controller or microprocessor could be programmed with “self-tuning” features, which can detect (by way of the encoders) position and velocity error and apply correction based on Proportional-Integral-Derivative (PID) gains to continuously modulate electric servo motor, which may improve performance.

Electric servo motor 302 may allow knowledge at all times of the dispenser's precise rotational position. The electric servo motor 302 will also provide a faster cycle time due to ability to move in both directions. The electric servo motor 302 can preferentially unload the dispenser to even out the load of tanks (e.g., cylinders) on the carousel (i.e. remove the top tank in position 1, then the bottom tank in position 5, then top tank in position 3, then bottom tank in position 7, etc.). Such load balancing is possible in the motor system because of increased speed and ability to rotate the carousel in either direction. Alternatively, the dispenser may unload one carousel layer at a time, from top to bottom, to ensure that the carousel has a low center of gravity. Other load balancing methods may be performed. Preferential loading or unloading (i.e., load balancing) reduces wear on mechanical components and therefore increases lifespan of the dispenser. It may also allow for use of lower cost mechanical components due to lower load and wear requirements. It may also allow for use of a lower power motor, which is beneficial in a hazardous environment.

In some embodiments, the electric servo motor will be mounted in a spring-loaded assembly which conveniently may allow the teeth of driving gear to remain meshed with the teeth of driven gear. The spring-loaded assembly may allow for radial movement of the electric servo motor relative to driven gear. Thus, the spring-loaded assembly can accommodate for runout of the driven gear, caused by “wobble” movement of the driven gear as it rotates. Runout can be measured from the high peak of the “wobble” to the low peak of the “wobble”. A runout compensation mechanism allows for the servo motor and gear system to still function with inaccuracy in circularity of the carousel (i.e., inherent inaccuracy due to large size of the carousel and common methods of construction, including large sheet metal assemblies).

In use, the driving mechanism can be configured to rotate the carousel to load and/or unload compartments of the carousel in a desired order. Instructions are programmed into microprocessor and/or an on-board controller to instruct the electric servo motor how/when to rotate. For example, the driving mechanism may be operated to preferentially unload the kiosk to even out the load of cylinders on the carousel (for example, to remove the top cylinder in position 1, then the bottom cylinder in position 5, then top cylinder in position 3, then bottom cylinder in position 7, etc.).

In another example, the carousel can be unloaded one shelf level at a time, from the top down, which may provide the carousel with a low centre of gravity, for example, starting from the top shelf, proceeding to the middle shelf and then the lower shelf. It will be understood that any combination of the operations above may be implemented in use. Conveniently, use of the servo motor driving mechanism to rotate the carousel may decrease cycle time (time it takes from start to finish for a customer transaction) from minutes to under 30 seconds. The carousel may be rotatable from any position to any other position in under 10 seconds. Preferential unloading mechanism may also be used to accommodate certain persons under accessibility requirements (in the United States, for example, the Americans with Disabilities Act [ADA]) by promoting access to certain areas of the carousel that are more accessible.

In some embodiments, a drive mechanism 300 for rotating carousel 53 includes an electric servo motor 302 and a gear set, including at least a driving gear or pinion gear 304 and a driven gear 306 to drive carousel 53 and rotate carousel 53 clockwise or counter-clockwise about a vertical axis. Drive mechanism 300 can thus rotate carousel 53 bidirectionally. The pinion links the motor, through an electromechanical brake, to the carousel gear. The pinion can be as small as possible as long as it is mechanically strong enough to transmit the load. The carousel gear may be attached to the carousel to transmit torque from pinion to carousel. The carousel gear may be as large as possible as long as it fits on the carousel. A larger carousel gear together with a smaller pinion generates a large mechanical advantage.

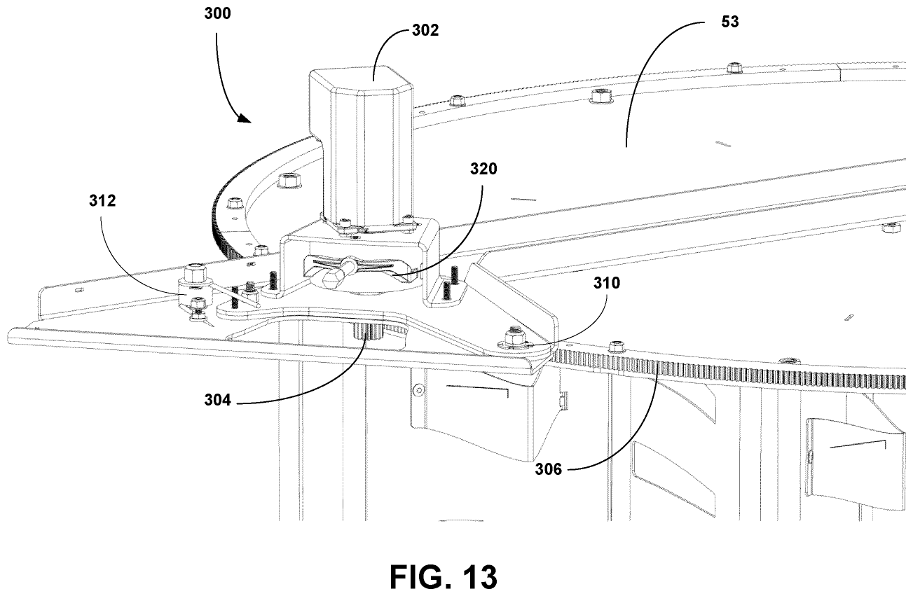

FIG. 13 illustrates, in a front perspective view, an example of a drive mechanism 300 for rotating a carousel, in accordance with some embodiments. FIG. 13 illustrates a view of drive mechanism 300 and carousel 53 in an embodiment, including a small motor (e.g., small servo motor) 302, spring, brake 320, pinion 304, runout compensation bearing 310, driven gear 306, and carousel 53. A servo motor 302 may be attached to a power transmission system (e.g., a gear based system, a pully/belt based system, a chain/sprocket based system, etc.) to rotate the carousel. Servo motors by nature (due to their integrated encoders) keep track of position, which ensures that the carousel is always in the position the controller thinks it is in. An electromechanical brake may be attached to the power transmission system to conditionally lock and unlock carousel movement. For example, a power off (spring applied) brake may prevent motion when no power is supplied. Having control of a brake on the carousel assists with allowing only authorized personnel (customers or service technicians) from accessing the carousel in appropriate positions (for example, to prevent theft). The electromechanical brake may have a manual override lever to allow the carousel to be rotated manually in the event of a power outage or other conditions which prevent the dispenser 30 from operating.

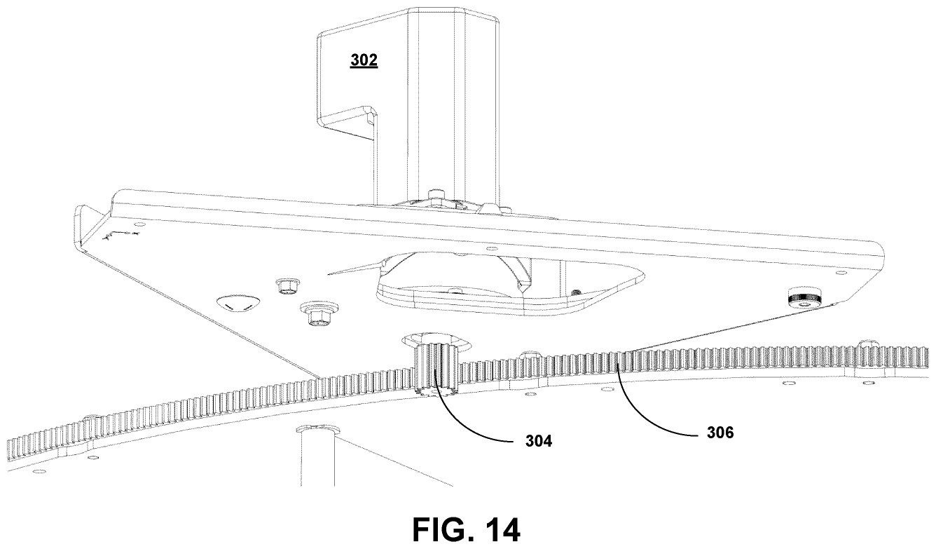

FIG. 14 illustrates an underside view of the drive mechanism of FIG. 13 showing the meshing of the pinion (small gear) 304 and the driven gear.

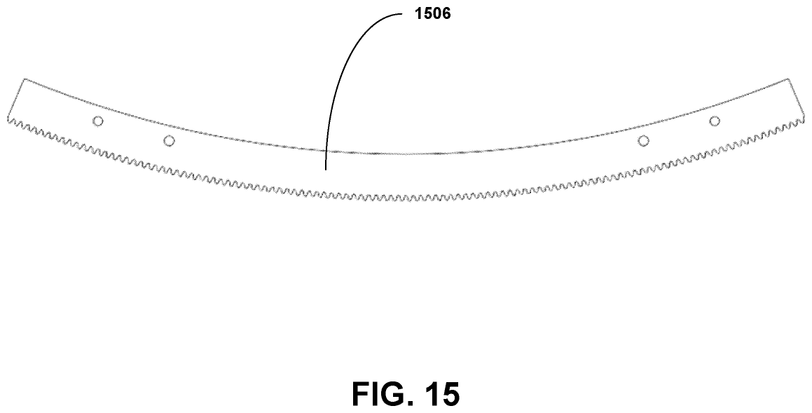

FIG. 15 illustrates, in an isolated view, an example of a portion (or segment) 1506 of the driven gear 306 of the drive mechanism of FIG. 13. FIG. 15 illustrates an isolated view of a “segment” of the driven gear, which when coupled in a series, are fastened to the carousel adjacent to each other, forming the gear. The segments are designed to optimize manufacturability, increase part quality, lower cost, and reduce weight.

Pinion gear 304 is rotatably coupled with electric servo motor 302. Pinion gear 304 can be very small relating to driven gear 306, providing a mechanical advantage, in an example, of approximately 40:1 or more. Such a mechanical advantage can allow for the use of a relatively small electric servo motor 302 to drive a heavy carousel 53, as the torque output by electric servo motor 302 is multiplied by 40 due to the gear ratio, in an example.

Pinion gear 304 meshes with a driven gear 306. Driven gear 306 can be integral with carousel 53 or affixed to carousel 53, in an example, with a nut and bolt or other suitable fastener, and can provide mechanical structure to carousel 53 as both a structural component and a part of drive mechanism 300.

Conveniently, electric servo motor 302 offer high torque and very high positional accuracy, as well as other features such as torque controls, velocity controls and braking capabilities.

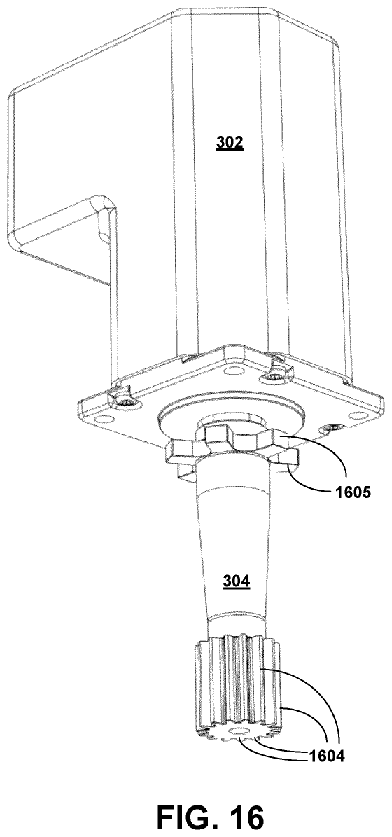

FIG. 16 illustrates, in a perspective view, an example of a motor 302 and pinion 304 of the drive mechanism of FIG. 13, in accordance with some embodiments. The pinion 304 interfaces with the motor via the central bore, the electromechanical brake via the six “fingers” 1605, and the driven gear via the gear teeth 1604.

### Servo Motor System

As noted above, a servo motor system offers many benefits over the actuator/latching design, including the fact that the carousel can be rotated in either direction. Servo motors 302 offer high torque and very high positional accuracy, as well as other features such as torque controls and velocity/acceleration controls. High torque will drive a heavy carousel using a relatively small motor. Small motors (e.g., small servo motors 302) may also be low power and non-sparking.

Electric servo motor 302 can be used to rotate carousel 53. Electric servo motor 302 can include encoders to provide position and speed feedback. Electric servo motor 302 can use such position feedback to control its motion and final position, forming a closed loop feedback system. Such a closed loop feedback system can be configured to determine whether electric servo motor 302 is doing what it was commanded to do. For example, if electric servo motor 302 is a little bit off (in terms of commanded position, torque, velocity, or other driving programming parameter), then electric servo motor 302 can automatically correct itself. This process can happen multiple times per second, which may provide accurate and reliable motor performance.

Encoders can determine where electric servo motor 302 is positionally, and can generate an error if electric servo motor 302 is unable to physically do what it is commanded to do.

In some embodiments, the encoders generate an error themselves. In some embodiments, processing done centrally, elsewhere at a connected data processor. In some embodiments, a processor is included with servo motor 302.

In an example, if an error is received, the controller can shut down dispenser 30 until the system can be “homed”, as discussed below.

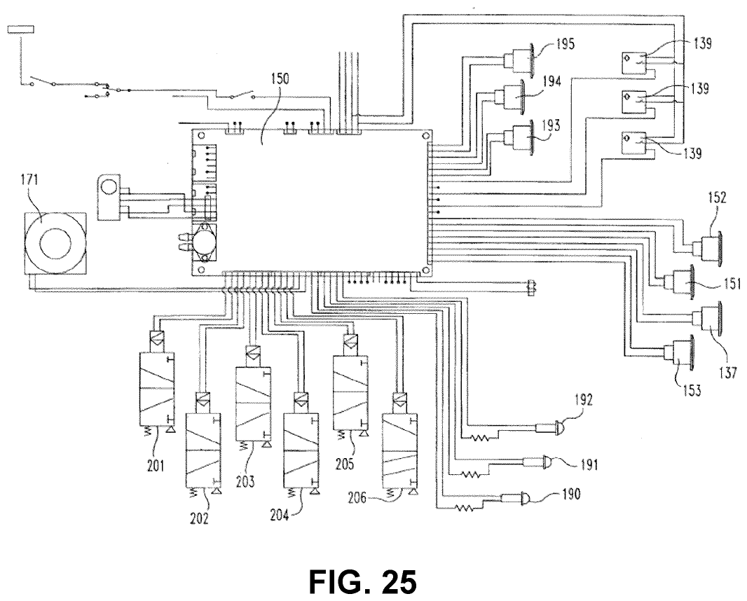

In some embodiments, the error message is sent to a controller such as controller 150 (see FIG. 25) and may be connected to the encoder. In some embodiments, a controller shuts down dispenser 30 (such as a central processor such as controller 150, onboard computer, or the on-board controller of the servo motor 302), and steps are performed in a “shut down”.

An electric servo motor 302 may be configured to have suitable velocity and acceleration and deceleration curves based on load requirements of carousel 53. Conditional torque limits can be set using software of electric servo motor 302 to prevent electric servo motor 302 from driving into an unexpected obstruction or “jamming” on debris or objects.

In some embodiments, a servo motor controller is included. In some embodiments, torque limits are set in the controller software or computer. In some embodiments, the dispenser will have a central computer along with an onboard servo controller. However, a board mount microprocessor can also be used to control the dispenser.

In some embodiments, electric servo motor 302 can be configured with “self-tuning” features, which can detect (by way of the encoders) position and velocity error and apply correction based on Proportional-Integral-Derivative (PID) gains to continuously modulate electric servo motor 302, which may improve performance.

Electric servo motor 302 may be mounted in a spring loaded assembly or a runout (wobble) compensation mechanism which conveniently may allow the teeth of driving gear 304 to remain meshed with the teeth of driven gear 306.

In some embodiments, the motor is mounted to a suitable location in the dispenser 30 and may be by way of a “spring loaded assembly”.

A spring loaded assembly may allow for radial movement of electric servo motor 302 relative to driven gear 306. Thus, the spring-loaded assembly can accommodate runout of driven gear 306, caused by “wobble” movement of driven gear 306 as it rotates. Runout can be measured by the delta of the high peak of the “wobble” to the low peak of the “wobble”.

Conveniently, the spring loaded assembly can allow electric servo motor 302, pinion gear 304 and driven gear 306 to operate in a low precision (e.g., sheet metal) part based environment.

The drive mechanism showing runout (wobble) compensation mechanism 310 is shown in FIG. 13. This mechanism pivots on a bearing which, due to its relative position, moves the pinion on a large circular arc which approximates a linear path due to its large radius. The runout compensation mechanism is spring loaded with torsion spring 312, forcing the pinion and driven gear to mesh at all times but allowing for the runout (wobble) or the carousel (which is present due to the imprecise nature of sheet metal parts). The runout mechanism 310 comprises a spring-loaded mechanism which allows the servo motor subassembly (with pinion, brake, etc.) to move in and out relative to carousel gear. The runout mechanism may be a linear or rotary mechanism (where the rotary system would be designed to approximate a linear mechanism by having the mechanism's center of rotation be as far from the pinion as possible).

All of the power transmission systems described herein (i.e., drive mechanisms) may be designed to provide large mechanical advantages (also called gear ratios, torque increase/speed decrease, etc.) to allow the use of a smaller and lower power motor. In embodiments where dispensers 30, 50 are in a hazardous environment, components require special certification to be used. These parts can be non-sparking and low power. Power transmission systems which offer large mechanical advantages (torque increase/speed decrease) allow for the use of smaller and lower power motors. The motor is small and low power so it can work in hazardous environments, but the power transmission system amplifies the power of the motor using mechanical advantage (at the expense of speed of the motor, which is still fast enough for the carousel application).

As described above, a carousel may be driven by an electric servo motor. Due to the electric servo motor's integrated encoder, the position of the carousel is always known. A motor shaft integrates into a power-off electromechanical brake. The brake stops movement of the carousel when power is not applied to the brake. When power is off, the brake redundantly engages (by mechanical means such as springs) to lock the carousel position and ensure that the carousel does not move, regardless of its position at that time. This functionality may also be used to prevent customers from rotating the carousel manually to steal cylinders. An optional manual override lever on the brake may allow owners/operators of dispensers 30, 50 to move the carousel manually and use the dispenser manually in the event of a power outage.

### Belt and Pulley Power Transmission System

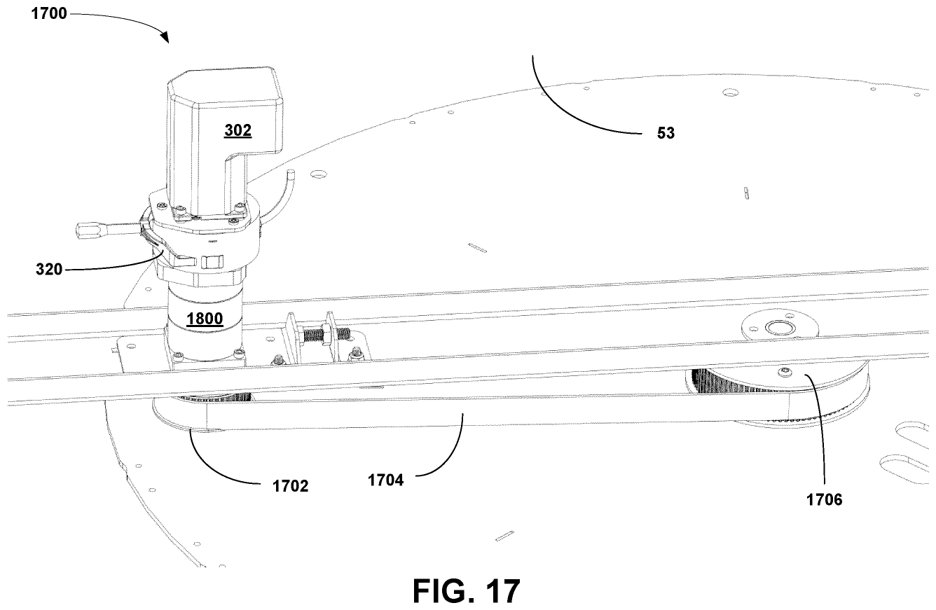

FIG. 17 illustrates an example of a belt and pulley power transmission system 1700, in accordance with some embodiments. A large gearbox 1800 facilitates large speed reduction/torque increase, allowing for the use of a smaller motor 302. With the synchronous timing pulleys and belt 1704, a small pulley 1702 is driven through the gearbox 1800 by the motor 302. The larger pulley 1706 relative to smaller pulley 1702 provides additional speed decrease/torque increase, again allowing for the use of a smaller motor 302. The larger pulley 1706 is bolted directly to the carousel 53 to couple movement. Synchronous timing belts and pulleys provide relatively precise and accurate movement. In some embodiments, features of the belt and pulley power transmission system 1700 include high torque transfer capabilities, long service life, no metal on metal contact like gear based or chain based systems, relatively quiet operation, and belt tensioning adjustment where the motor, brake, and gearbox subassembly is adjustable to allow for correct belt tensioning. In some embodiments, the belt may comprise a reinforced flexible belt, rubber like material with tensile additives for strength. The belt couples movement from the smaller pulley to the larger pulley.

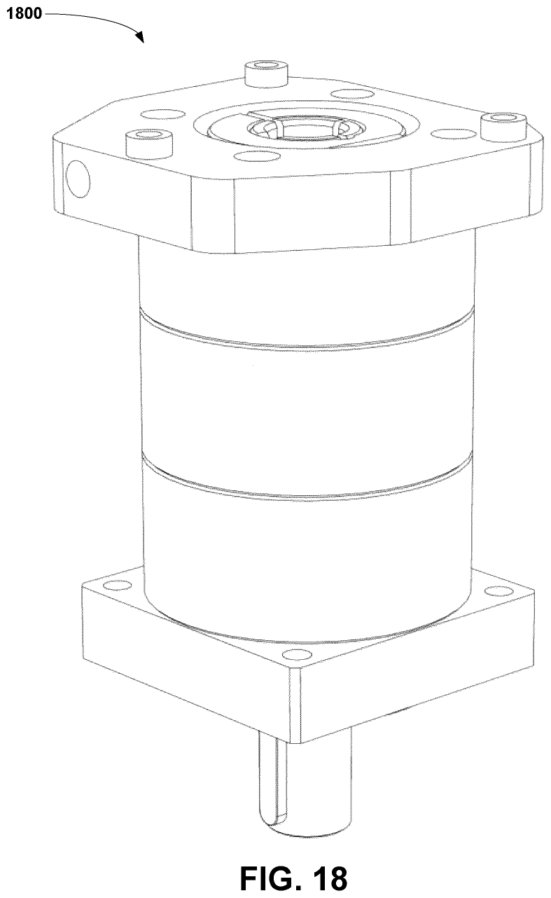

FIG. 18 illustrates an example of a gearbox 1800, in accordance with some embodiments. The gearbox 1800 may be used in a belt and pulley system, a chain and sprocket system, and a direct drive system.

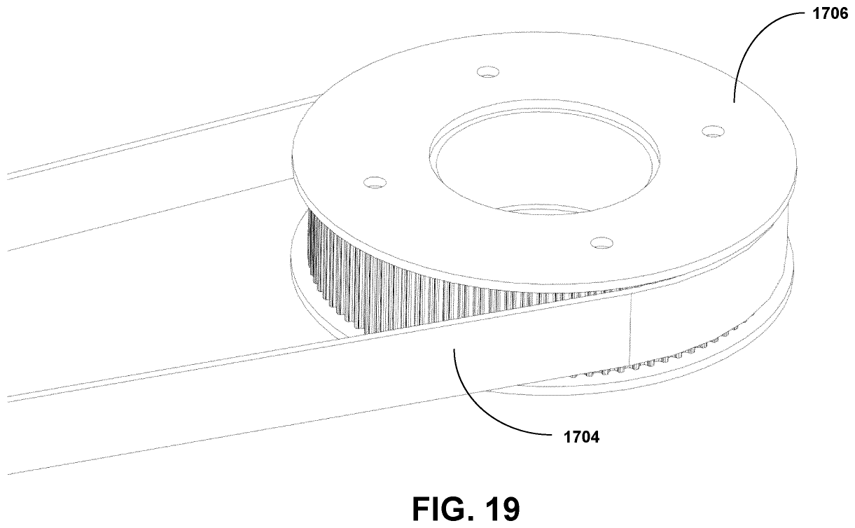

FIG. 19 illustrates an example of a synchronous timing belt 1704 and large pulley 1706 attached to carousel top, in accordance with some embodiments. In some embodiments, teeth (not shown) for the belt are trapezoidal or curvilinear in shape and may look similar to gear teeth.

### Gear Power Transmission System

FIG. 13 shows an example of a gear power transmission system 300. As noted above, a relatively large difference in size between the pinion gear 304 and the carousel gear 306 provides a relatively large torque increase/speed decrease. The large gear 306 is integrated into the carousel 53 as a ring gear. In some embodiments, the gear may be manufactured at a lower cost, and provides high torque transfer capabilities. In some embodiments, the gear may comprise a runout compensation mechanism. For example, a motor 302 and other components attached to the motor are mounted on a plate which rotates about a bearing. The mounting plate is spring loaded, ensuring gear teeth are 306 always engaged. Because the system is allowed to move in and out, variations in the carousel's rotation (i.e., a “runout” that looks like a “wobble”) are absorbed which mitigates any damage that the runout may cause to components or overall system performance.

### Worm Gear Power Transmission System

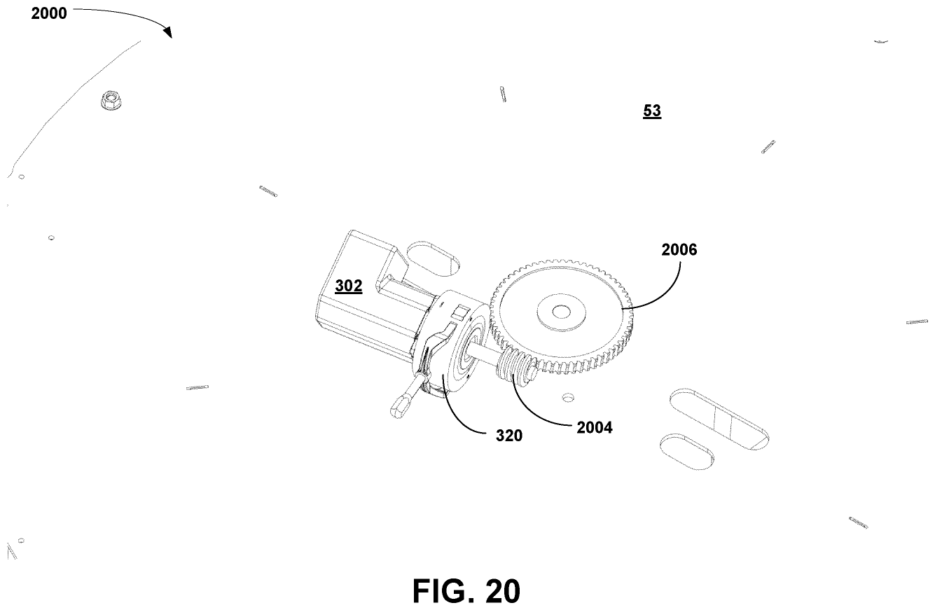

FIG. 20 illustrates a view of a worm gear power transmission system 2000, in accordance with some embodiments. The servo motor 302, electromechanical brake 320, worm 2004, and worm gear 2006 (mounted to the carousel) are shown. The worm gear power transmission system 2000 is similar in idea to the gear system 300, though the worm gear drives have some different characteristics. For example, the motor 302 would be at right angle from worm gear 2006 due to the inherent design of worm drives. In some embodiments, work gears 2006 are extremely compact, provide a large mechanical advantage, and provide good value for the cost. The worm (worm screw) may link the motor 302 to the carousel 53 (through the electromechanical brake 320). The worm gear 2006 may be attached to the carousel 53 to transmit torque from the worm 2004 to the carousel 53.

### Chain and Sprocket Power Transmission System

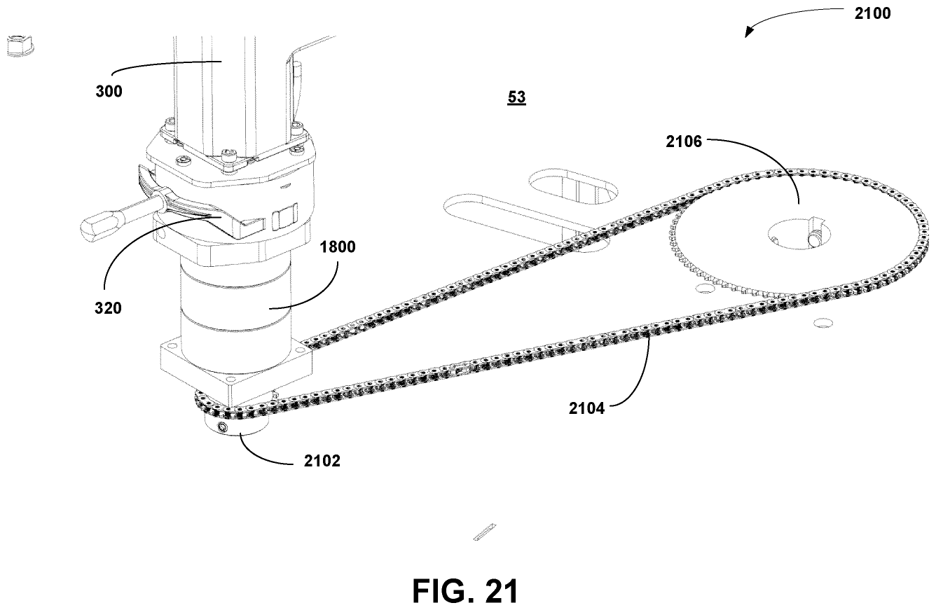

FIG. 21 illustrates an example of a chain and sprocket power transmission system 2100, in accordance with some embodiments. The motor 302, electromechanical brake 320, gearbox 1800, small sprocket 2102 (attached to output of gearbox), large sprocket 2106 (attached to carousel), and chain 2104 are shown. The chain and sprocket power transmission system 2100 is similar to the belt and pulley system 1700, but would use sprockets instead of pulleys and a chain instead of the belt. A small sprocket 2102 may be at the motor end (after the brake and gearbox), while a larger sprocket 2106 may be at the carousel 53 end. The chain 2104 couples movement between the sprockets. The chain 2104 may be a chain with multiple links (e.g., a metal roller chain). A gearbox 1800 before the first sprocket 2102 provides the large mechanical advantage. In some embodiments, the chain and sprocket provides high load capabilities, are good value for the cost, and are more compact than belt and pulley system 1700.

### Direct Drive Power Transmission System

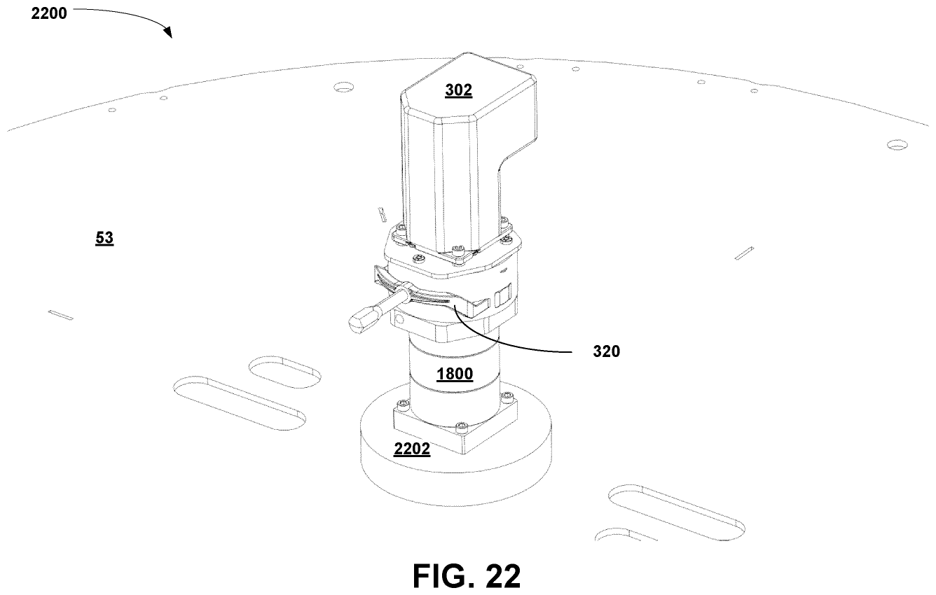

FIG. 22 illustrates an example of a direct drive power transmission system 2200, in accordance with some embodiments. The motor 302, electromechanical brake 320, gearbox, adapting plate or coupler 2202, and carousel 53 are shown. In a direct drive power transmission system 2200, a motor 302 shaft is coupled directly to the carousel 53 via a shaft coupler or some sort of flange. A gearbox 1800 before the coupler 2202 provides the large mechanical advantage. In some embodiments, the direct drive provides a minimization of components, is a relatively simple design, and involves no metal on metal contact.

### Driving Mechanism

In use, driving mechanism 300 can be configured to rotate carousel 53 to load and/or unload compartments 57-64 of carousel 53 in a desired order.

In some embodiments, instructions are programmed into controller 150, computer and/or an on-board controller to instruct electric servo motor 302 how/when to rotate.

In an example, driving mechanism 300 may be operated to preferentially unload dispenser 30 to even out the load of cylinders on carousel 53 (for example, to remove the top cylinder in position 1, then the bottom cylinder in position 5, then top cylinder in position 3, then bottom cylinder in position 7, etc.).

In another example, carousel 53 can be unloaded one shelf level at a time, from the top down, which may provide carousel 53 with a low centre of gravity, for example, starting from shelf level 54, proceeding to shelf level 55 and then shelf level 56.

It will be understood that any combination of the operations above may be implemented in use.

Conveniently, use of driving mechanism 300 to rotate carousel 53 may decrease cycle time (time it takes from start to finish for a customer transaction) from minutes to under 30 seconds. Carousel 53 may be rotatable from any position to any other position in under 10 seconds.

Encoders of electric servo motor 302 can detect positional and rotational information related to electric servo motor, from which positional and rotational information of carousel 53 can be inferred, at any time, even when carousel 53 is in between stationary positions. A rotational position can be measured in degrees relative to a reference “home” position.

In some embodiments, the encoders of electric servo motor 302 provide positional/rotational information of the electric servo motor 302. In some embodiments, the encoders provide positional/rotational information of carousel 53.

In some embodiments, dispenser 30 can include one or more carousel position sensors, for example, disposed on carousel sensor tower 200 disclosed herein, to detect a position of carousel 53.

In some embodiments, one or more carousel position sensors can be magnetic position sensors.

In some embodiments, one or more carousel position sensors can be a contactless sensor, such as an inductive proximity sensor, or other suitable sensor, affixed to carousel 53 and main frame 42 to detect when carousel 53 is in a designated “home” position.

In some embodiments, a rotational position of carousel 53 can be rotated to a reference, “zero” or “home” position of a fixed point on carousel 53 relative to a fixed point on main frame 42, using a single “homing” switch. The “home” position can be designated as position “1” in an “8” position carousel.

In some embodiments, the switch can be hardware and/or software. In some embodiments, switching can be programmed into controller 150 to operate dispenser 30. In some embodiments, carousel 53 moved to home position by rotating until the home sensor is detected. In some embodiments, carousel 53 is rotated to various positions to allow for access to different cylinders.

In some embodiments, there is a combination of the driving mechanism of FIG. 11 (driving from bottom of carousel) and electric servo motor (driving from top of carousel). In some embodiments, the motor driving mechanism can be located at the bottom of the carousel.

The carousel can be prevented from rotating (for example, in a clockwise or counter clockwise direction) by a lock mechanism, which may be located at the top of the carousel 53. Rotation may be prevented, for example, once a door is opened allowing access by customer or service personnel. An open door can be sensed by a door sensor and triggers the lock mechanism to lock the carousel.

In one example, the lock mechanism can be in the form of a metal “claw” like arm affixed to an electromechanical cylinder with a proximal end pivotally mounted to a horizontally extending wall, in turn, attached to the main frame. The extendable piston rod has a bifurcated end pivotally attached to arm, in turn, fixedly attached to arm having a proximal end pivotally mounted to wall.

The “claw” arm has a proximal end fixedly mounted to arm with the distal end forming a catch recess releasably and lockingly engageable with the outwardly located vertical divider forming the compartments. For example, once the carousel has been rotated in a clockwise or counter clockwise direction thereby aligning three compartments with the three propane doors, the locking mechanism cylinder is activated pivoting the distal end outwardly until the claw recess in engaging and retaining the divider vertical structure preventing any bidirectional movement. Once the doors are closed and the carousel is called to rotate, the lock mechanism cylinder is activated to withdraw the claw from the vertical divider tube allowing the carousel to rotate. In sequential fashion, upon receipt of a command, the carousel is caused to rotate positioning the compartments in sequential fashion behind the doors.

Safety is of primary concern in tank dispensers since the cabinets could store a number of propane cylinders. In those dispensers having conveyors or rotatable carousels, there is also concern that the consumer may be injured by the movable conveyor and/or carousel. Locking mechanisms (e.g. claw or electromechanical brake) can prevent rotation of the carousel whenever a compartment door is open allowing for the insertion or removal of a cylinder. A locking mechanism prevents rotation of the inside carousel anytime a door is open using a locking mechanism.

Further, locking mechanisms can be located in such a position to minimize interaction with the external environment such as dirt or ice. For example, the locking mechanism could be located at the top of the enclosure where it is shielded from the environment.

In another example the carousel can be prevented from rotating using a electromechanical brake. A spring applied, electromagnetically released brake can be affixed to the output shaft of electric servo motor. The brake can be controlled electronically, such that the brake is activated/engaged with no voltage present, and deactivated/disengaged when voltage is applied. Therefore, in the case of a power outage, the brake is automatically applied, preventing the carousel from rotating preventing theft or misuse. In some instances, the carousel can be prevented from rotating using the holding torque of the electric servo motor as a brake. To retain the carousel from rotating, electric servo motor may be configured to apply a holding torque, which may be suitable for preventing the carousel from rotating if a customer tries to move it by hand.

In the case of either the claw lock mechanism or the electromechanical brake affixed to the servo motor drive shaft, the system is equipped with a method for manual release or manual override of the lock or brake. For the claw lock mechanism, the claw can be pried back to allow rotation of the carousel. In the case of the electromechanical brake, the electromechanical brake is equipped with a lever-style manual release. The incorporation of this manual release or manual override on the brake is needed in the event that a service technician or store associate is required to use or service the kiosk without software or power, such as in the event of a mechanical or electrical outage or failure.

Conveniently, using each of these catching/locking mechanism over other options may be advantageous, including a combination of more than one mechanism.

Carousel 53 can be prevented from rotating (for example, in a clockwise or counterclockwise direction as viewed in FIG. 9) by a claw lock mechanism 210, which may be located at the top or bottom of carousel 53. Rotation may be prevented, for example, once a door is opened allowing access by a consumer. In some embodiments, a claw lock mechanism can be used in combination with a electromechanical brake, described in further detail below. The locking mechanism could be using the “claw” mechanism or accomplished using the torque of the motor or a combination of the motor torque and attached servo motor brake.

In some embodiments, an open door can be sensed by a door sensor and triggers claw lock mechanism 210 to lock carousel 53.

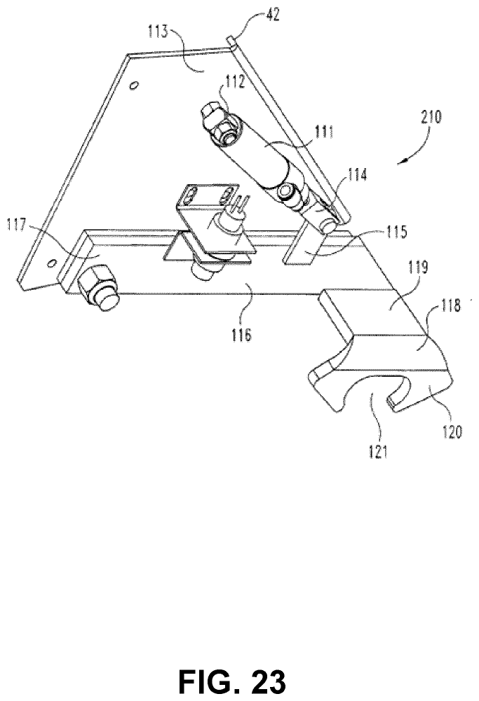

As shown in FIG. 23, in some embodiments, claw lock mechanism 210 has an electromechanical cylinder (e.g. a linear actuator) 111 with a proximal end 112 pivotally mounted to a horizontally extending wall 113, in turn, attached to main frame 42. The extendable piston rod has a bifurcated end 114 pivotally attached to arm 115, in turn, fixedly attached to arm 116 having a proximal end 117 pivotally mounted to wall 113.

A catch arm 118 has a proximal end 119 fixedly mounted to arm 116 with the distal end 120 forming a catch recess 121 releasably and lockingly engageable with the outwardly located vertical members forming the compartments. For example, once the carousel has been rotated in a clockwise direction thereby aligning three compartments between members 123 and 67 with the three doors 37-39, cylinder 111 is activated pivoting the distal end 120 outwardly until the top end 124 of member 125 is located within recess 121. The carousel is thereby prevented from rotating in either direction. Similarly, as the carousel is rotated an additional ⅛ turn, a new set of carousel compartments are located behind the doors thereby positioning top end 122 of vertical member 123 (shown in FIG. 9) immediately adjacent hand 120 with the cylinder 111 then being activated causing the hand to pivot outward until the top portion 122 is located within recess 121. Once the doors are closed, cylinder 111 is activated to withdraw the hand from the vertical member allowing the carousel to rotate for an additional ⅛ turn. In sequential fashion, upon receipt of a command, the carousel is caused to rotate positioning the compartments in sequential fashion behind the doors.

Safety is of primary concern in cylinder dispensers since the cabinets could store a number of LPG cylinders. In those dispensers having conveyors or rotatable carousels, there is also concern that the consumer may be injured by the movable conveyor and/or carousel. Locking mechanism 210 can prevent rotation of carousel 53 whenever a compartment door is open allowing for the insertion or removal of a cylinder. Claw lock mechanism 210 prevents rotation of the inside carousel anytime a door is open using a locking mechanism consisting of an arm and an electromechanical actuator mounted at the top of the dispenser.

Further, claw lock mechanism 210 can be located in such a position to minimize interaction with the external environment such as dirt or ice. In some embodiments, claw lock mechanism 210 is located at the top of the carousel beneath members 83 and 84 and top wall 32, as shown in FIG. 2, which may minimize claw lock mechanism 210 from sticking as a result of foreign material including dirt and ice.

In an alternative, the claw does not have to get “pushed” out of the way, and the claw can come directly perpendicular to the tangent line of the carousel.

In some embodiments, carousel 53 can be prevented from rotating using an electromechanical brake 320 attached to the servo motor output shaft.

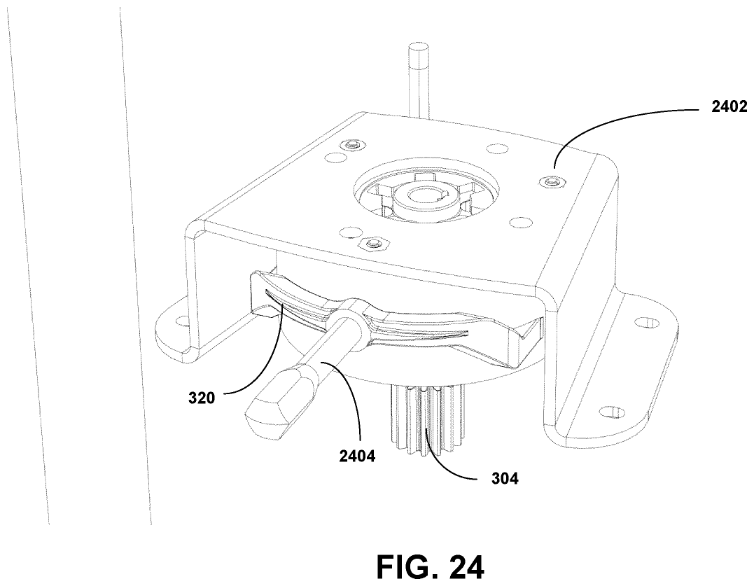

FIG. 24 illustrates, in a perspective view, an example of a brake 320, in accordance with some embodiments. FIG. 24 illustrates the brake 320, the brake's attached “friction plate” 2402, and a clear view of the spring loaded “manual release” lever 2404.

A spring applied, electromagnetically released brake can be affixed to the output shaft of electric servo motor 302. The brake can be controlled electronically, such that the brake is engaged without electrical power, and disengaged when receiving electrical power. Therefore, in the case of a power outage, the brake is automatically applied, preventing carousel 53 from rotating.

In some embodiments, carousel 53 can be prevented from rotating using holding torque of electric servo motor 302 as a brake.

To retain carousel 53 from rotating, electric servo motor 302 may be configured to apply a holding torque, which may be suitable for preventing carousel 53 from rotating if a customer tries to move it by hand.

In some embodiments, the servo motor brake can be used in combination with the holding torque of the servo motor, and in combination with a claw lock mechanism, or any combination thereof.

Conveniently, using each of these catching/locking techniques over other options may be advantageous.

FIG. 25 illustrates, in an electrical schematic, an example of wiring connections between a controller such as Inputs/Outputs board (in an example, a pneumatics board) and sensors and relays (or in an example, solenoid valves), in accordance with some embodiments.

In some embodiments, solid state relays may be used on higher power components, such as door locks or electromechanical brakes, where the outputs from the controller cannot supply enough power to operate the component. Solid state relays, unlike electromechanical relays, do not have moving mechanical contacts which can be prone to arcing or sparking. Non-sparking components are ideal for use in hazardous environments.

FIG. 25 illustrates six solenoid valves 201-206 used to control the flow of gas, in an example, nitrogen, to cylinders to rotate the carousel, lock carousel in place, and lock the three doors in the closed position. In some embodiments, solenoid valves can be replaced by electromechanical relays to control actuation of electromechanical components.

A controller 150 may be a computer or any other suitable microprocessor or controller. Also, solenoid valves may or may not be used, and in their place electromechanical components can be used. Controller 150 can include on board intelligence (using a suitable computing device).

Controller 150 can include a microprocessor that receives the sensed data from sensors such as the three door sensors 137, 151 and 152 (shown in FIGS. 2 and 6) and any other sensor disclosed herein. Controller 150 can also be in communication with any driving mechanism disclosed herein, such as electric servo motor 302 and brake 320.

Sensors 137, 151 and 152 can be connected to the microprocessor included in controller 150 as well as solenoids 202-204 (or relays) in turn connected to the door cylinders 134 with one cylinder (or electromechanical door lock) provided for each door.

In some embodiments, a motion sensor may be used. The motion sensor may be attached to the frame to detect movement outside the Kiosk within a certain threshold, can turn on external LED's based on this input, can put Kiosk to “sleep” if it does not detect motion (e.g., turn off lights and/or other electrical components to save power) and/or can use this input to tell the Kiosk to display an advertising message, or to play audio through the speaking offering instructions to potential customers, etc.

In some embodiments, an ambient light sensor may be used. The ambient light sensor may be attached to the frame to detect ambient light outside the Kiosk, or integral to the display circuitry, can turn on LED's at night based on this input, can contribute to “sleep” function as described above, and/or can lower or raise brightness of display based on this input.

Solenoid 205 (or a relay) can be associated with the locking cylinder 111 (carousel locking mechanism) connected to the microprocessor to limit rotation of the carousel. Solenoid 206 connected to the microprocessor in the pneumatic board is connected to the cylinder 102 (shown in FIG. 11) to drivingly rotate carousel 53. The remaining solenoid 201 is connected to solenoids 202-206 (or relays) to control the flow of nitrogen to the remaining solenoids 202-206 which in turn are connected to the respective cylinders (or electromechanical door locks) to lock the three doors, cause rotation of the carousel, and lock the carousel in place. Three LEDs 190-192 are associated one each with doors 37-39 and light when their respective top, middle or bottom door is open. Controller 150 is the component that controls the mechanical operation of the kiosk. Controller 150 reads the input signals from the sensors connected to the board and sends a signal to the appropriate solenoids.

In some embodiments, controller 150 is a circuit board more generally, and some/all of the pneumatics may be replaced for e.g., with electromechanical components.

The following may be magnetic sensors, normally open and close an electrical circuit (or normally closed and open) once the appropriate magnet is in their immediate proximity: Home sensor 153, Top Door sensor 137, Middle Door sensor 151, Bottom Door sensor 152, Lock sensor 193 (if used), in some embodiments, Count sensor 194, and Drive Cylinder sensor 195. Other sensors are also contemplated.

Home sensor 153 detects when the carousel has rotated and is in the “Home” position. That is, when the three initial compartments are facing the doors directly. Such provides a starting point for the dispenser. Home sensor may be located at a suitable position on dispenser 30. The home sensor 153 may be a proximity sensor (of any type—inductive, capacitive, ultrasonic, etc.), limit switch, or any other type of mechanically actuated sensor/switch. The home sensor 153 may detect a “flag” or marker attached to the carousel which aligns the carousel to a “home” position. In some embodiments, the flag may be an RFID tag, a QR code or barcode, or any other marker affixed to the carousel. This allows the servo motor to have a reference from which to track items. For example, the carousel may be a certain number of degrees counter clockwise from the home position.

In some embodiments, top Door sensor 137 detects when the “Top” door has been shut closed. This magnetic sensor is mounted on the left side of the compartment. The door has a magnet mounted on so when the door is closed, the magnetic field of the magnet closes the circuit allowing the electrical current to flow to controller 150 which processes the input signal. If the current flow is interrupted, that is, when the door is open; then, the board sends and output signal (electrical current) to turn on LED Light 190 and stay on until the door is closed.

Middle Door sensor 151 has the same operation as the Top Door sensor and instead lights LED Light 191 when the middle door is open.

Bottom Door sensor 152 has the same operation as the Top Door sensor and instead lights LED Light 192 when the bottom door is open. In embodiments with different numbers of levels, there may be 1 LED for each level, controlled in a similar manner as above.

Lock sensor 193 determines if the locking arm is in the appropriate position locking the carousel in place so it cannot be rotated. Once the board senses a signal corresponding to when the carousel is not locked the board sends an output signal to the Solenoids 201 and 206 so the Drive Cylinder 102 can be actuated and the carousel can rotate. In some embodiments, other locking mechanisms such as servo motor torque or brake receive output signals from the board.

Count sensor 194 senses when the carousel is advancing to its next position. A magnet located in an upright within the main frame 42 will be aligned with the count sensor 194 for a split second. When the board reads that signal, it waits for a short input coming from the lock sensor 193 and then cuts the output voltage going into the solenoid 206 so the drive cylinder 102 stops pushing and retracts to its initial position. The retraction of cylinder 102 occurs in combination of the input signal coming from the lock sensor 193 once the carousel has been locked in place.

In some embodiments, a home sensor may be used in place of a count sensor, and used in tandem with the servo encoder positive positioning. It may be used when a home position command has been initiated. Counting of rotations can be completed by the controller dependent on the number of rotate command requests from the controller and position feedback from the encoder.

Drive Cylinder sensor 195 senses when the drive cylinder 102 is fully retracted and sends an input signal to board 150. When the board receives this signal, it cuts the output voltage going to Solenoid 201 and checks that Solenoid 206 is not energized. Thus, drive cylinder 102 remains fully retracted and ready for the next rotation.

Solenoid 205. When the board is controlling a rotation, the board checks for the input signal from the Drive Cylinder 102 and the absence of a signal from the Lock sensor 193. When the rotation command starts, it sends an output signal to Solenoid 201 to supply nitrogen to solenoid 205 and unlock the carousel so the rotation can be started. Once the board detects the absence of the input signal from the Drive Cylinder sensor 195 and reads the input from the Count sensor 194, board 150 cuts the output current off going to solenoid 205 so the locking arm extends and can lock the carousel back into position.

In some embodiments, with the use of the servo motor, when the carousel is commanded to rotate the electromechanical brake will release and the carousel will rotate to the commanded position. Once the position is confirmed using the encoder positioning the controller will complete its task.

Door Solenoids 202, 203 and 204 are the solenoids supplying nitrogen to the door lock associated with doors 37-39 so that the latch can retract and the doors can open when required. Solenoids 202-204 receive signals from board 150 and act in combination with the Top, Middle and Bottom Door sensors 137, 151, & 152 respectively.

Cylinder sensors 139 are sensors (e.g. normally open) which detect when a cylinder has been placed inside a compartment. Three sensors 139 are provided with a separate sensor for each compartment forward facing compartment. When the cylinder is inside the compartment, it changes the electrical circuit allowing the board to see an input for the top, middle and bottom compartments respectively. In the case of an exchange, the first door is going to open for the customer to insert the empty cylinder. A particular door opens when the board sends an output signal to solenoid 201 plus solenoid 202, or solenoid 203, or solenoid 204 for the top, middle or bottom doors respectively.

In some embodiments, controller 150 can connect to the web via cellular modem, or by WiFi, other wireless communication protocol, or by hard-wired connection. The connection can be used to facilitate the connection to a purpose-built web portal that will give the operator remote control functionality for the kiosk and inventory and performance monitoring and control capabilities including transaction tracking. The modem may also be used for global position service (GPS) tracking of the dispenser 30.

A web portal may be used to communicate back and forth to kiosk by way of controller 150. A remote computing device may send codes to kiosk (via “portal”), so that when user puts in code, a door lock rotates and the door opens, providing a secured dispensing system. The portal may also provide remote visibility into the machine status (e.g., is the dispenser working properly, is there an error, etc.), show inventory of cylinders (e.g., notify machine owner of need to replace empty cylinders, show sales information (e.g., machine owner may see how many cylinders have been sold, at what times, etc.), and provide remote control functionality (e.g., machine owner may rotate the carousel and perform other operating functions remotely.

A portal providing communication with a remote computing device can be used to download updated versions of software to controller 150, to report into portal with status messages (e.g., that the dispenser is alive), report problems, leaks of propane, sensor input statues, and the like.

Controller 150 can be configured to monitor its operational status and that of the dispenser using a variety of measures and can be “programmed” to report issues, status, and the like, via records sent to the portal as well as email and eventually text to multiple contacts across multiple reporting events/issues (using its connections to the portal, and in some embodiments, independently of the portal).

Embodiments of a dispenser, and components therein, as disclosed herein, can be powered by connection to a standard wall outlet. In some embodiments, power may be supplied by solar power using a suitable photovoltaic mechanism (e.g., a solar panel on the roof of the dispenser), which may allow deployment of the dispenser in areas that do not have available wall power. The solar panel can be used as the main power system, or as a redundant backup system if power from the wall is lost. If used as the main power system, the dispensing machine may be placed in non-traditional areas, such as campgrounds, beaches, etc., where the machine could typically not be placed because of lack of electrical power. In combination with a modem, this allows the dispensing machine full functionality in a wide range of environments.

A battery for the dispenser may be connected to the system. The battery may be chargeable through standard AC power supplied by buildings and other traditional infrastructure. This can provide redundant power in the event of a power outage. The battery system may also be configured to be charged via a solar panel system, which would allow the dispenser to be located away from traditional infrastructure in locations like parks, campsites, and the like. In some embodiments, the dispensing machine may be charged from an AC source before it is installed in the field (e.g., while still in the factory, before the dispensing machine has access to solar energy).

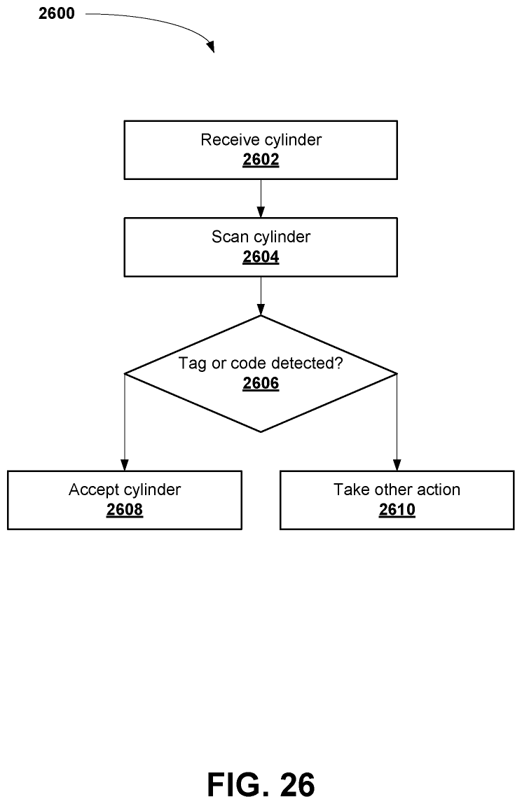

FIG. 26 illustrates, in a flowchart, an example of a method 2600 of exchanging a cylinder in a dispenser, in accordance with some embodiments. The method 2600 comprises receiving 2602 a cylinder in a dispenser. A scanner may be positioned in the dispenser to scan 2604 the cylinder for a tag or code at a predetermined location of the cylinder. For example, the scanner may be an RFID scanner sensing an RFID tag on the cylinder. Alternatively, the scanner may be a barcode reader scanning a QR code or other barcode on the cylinder. If the scanner receives 2606 an RFID tag or barcode, then the dispenser may accept 2608 the cylinder since the location of the tag or barcode scan would only be received by the scanner when the cylinder is placed in the proper position. Otherwise 2606, the dispenser may take other action 2610. For example, the dispenser may reject the cylinder, display a message to the user to readjust the cylinder, note the location of the cylinder and send a message to an operator/owner, and/or charge a premium to accept the cylinder. In some embodiments, a cylinder may be rejected if it does not have a tag, or if the cylinder is expired. Other steps may be added to the method 2600.

In some embodiments, when the dispenser detects a defective component of issue (or may receive a manual input that there is a defective component or other issue), the dispenser may automatically avoid having to use those components by using other components. For example, if a door lock is broken, then the dispenser will limit vending out of other doors until that lock is replaced or fixed. Automatic “detection” process may be enhanced with machine learning—using data input programmatically and/or by collection and interpreting data. In some embodiments, this may be performed at a machine level to identify systematic problems with that machine and/or performed at a macro level to determine systematic maintenance problems across all machines, or problems by geographical location, etc.

In use, in the case that the top door opens, board 150 checks for an input signal from the Top sensor 139 immediately after it reads the input signal for the Top Door sensor 137 which indicates that the door is closed. If board 150 does not read the input signal from the Top sensor, it will open the Top Door two more times by energizing the outputs for solenoid 201 and solenoid 202. If the board does not receive an input signal after the third attempt, it will send a command to the main board to void the transaction so the customer will not be charged.

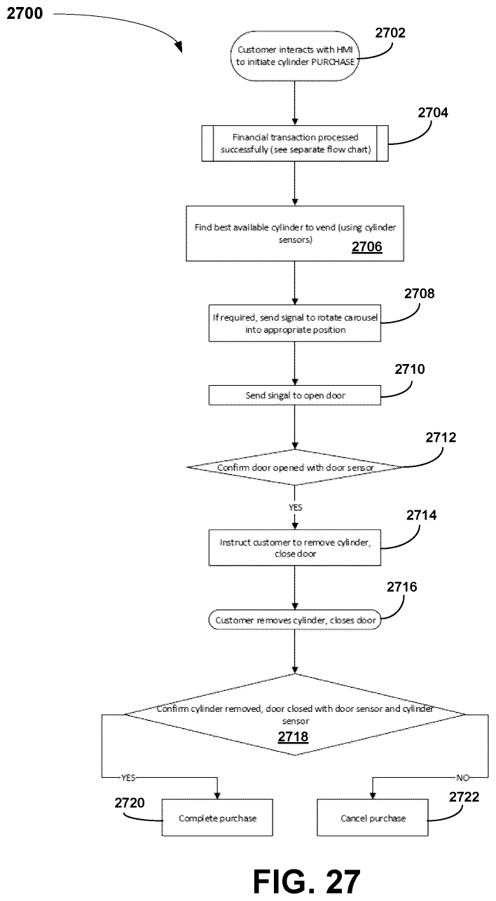

If board 150 receives an input signal from the Middle cylinder sensor 139, it will send an output signal to solenoid 201 and solenoid 203 so the Middle Door opens and the customer takes the full cylinder out of the compartment. Once the board detects that the Middle Door has been closed by reading sensor 151, it checks for the absence of signal from the Middle Cylinder or Cylinder sensor 139. If the board detects an input signal, it opens the door again so the customer has another opportunity to retrieve the cylinder. The machine does this one more time if the cylinder was not taken out the second time. If this happens, the board is going to “assume” that there is a malfunction of the sensor and it will send a command to charge the customer and report an error in the database. If in fact, the board does not see a signal from the Middle sensor, it will send a command to complete the transaction charging the customer. That is to avoid losing a cylinder in the case that there was a malfunction of the cylinder sensor. The board will then send a command to report an error in the database so the sensor can be inspected and replaced if necessary. (see FIG. 27)

During the purchase of a full cylinder, the paragraph above describes the process that occurs to dispense a cylinder. The sequence would be the same for doing an exchange or a purchase using different compartments. The only difference is that the board is going to look for input signals from other ports and also send output signals to the appropriate ports.

FIG. 27 illustrates, in a flowchart, an example of a method 2700 of purchasing a cylinder in a dispenser, in accordance with some embodiments. In some embodiments, the best available cylinder to vend may depend on the scenario. For example, an accessibility icon may be used to select a cylinder from a lower level.

At block 2702, a customer interacts with the HMI to initiate a cylinder purchase. I.e., an input/output component of the HMI receives input from the customer.

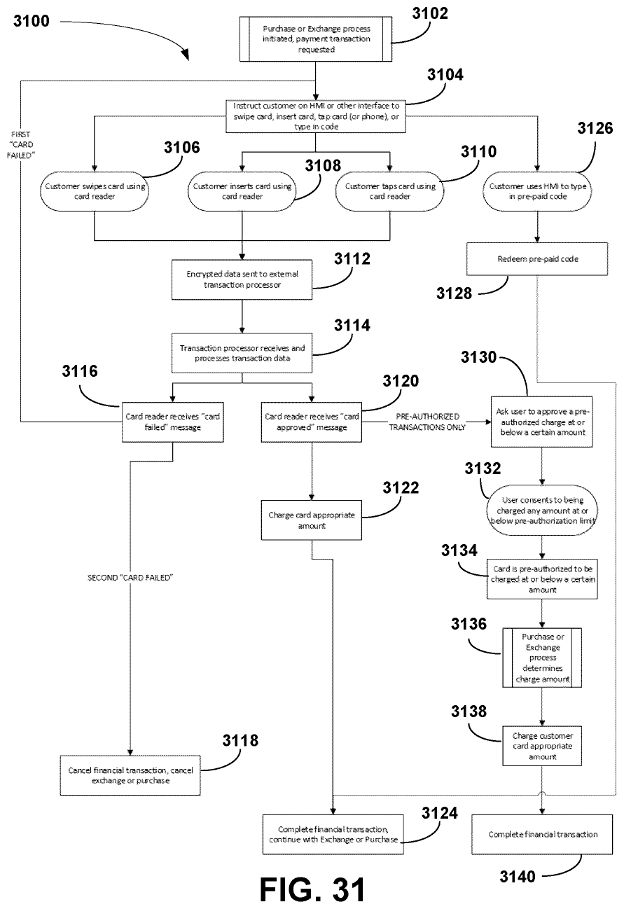

At block 2704, a financial transaction associated with the purchase is processed successfully (see FIG. 31).

At block 2706, a best available cylinder to vend is determined. In some embodiments, cylinder sensors are used in this step. In some embodiments, load bearing criteria may be used to balance the carousel by selecting a compartment or bay that would optimize weight distribution if a cylinder was removed from that compartment. By optimizing weight distribution using programmable logic and mechanical manipulation of the carousel, lower power electrical components (e.g. servo motor) can be integrated in the design which are more suitable for use in a hazardous environment.

At block 2708, a signal is sent to rotate the carousel into an appropriate position (i.e., so that the determined cylinder is in a compartment behind a corresponding door. If the carousel is already at the appropriate position, then this step is not required.

At block 2710, a signal is sent to open (e.g., unlock) the door.

At block 2712, the door sensor is used to confirm that the door is open.

At block 2714, a message is sent (e.g., via HMI, via speaker or text display) to the customer to remove the cylinder and close the door.

Once the customer removes the cylinder and closes the door 2716, then at block 2718, a cylinder sensor is used (as described above) to confirm that the cylinder was removed, and a door sensor is used (as described above) to determine that the door is closed.

If the cylinder is confirmed to be removed and the door is confirmed to be closed 2718, then the purchase is completed 2720. Otherwise 2718, the purchase is cancelled. Other steps may be added to the method 2700.

In some embodiments, when a full cylinder is taken out of the Bottom Door compartment, the board will do the process for an exchange by receiving the empty cylinder into the Bottom Door compartment, and then it will do a rotation to the next set of compartments in the carousel as previously mentioned and dispense the full cylinder from the Top Door compartment.

In an exchange scenario once the customer pays for the exchange a door with an empty space behind it will open to accept the empty cylinder. One the cylinder is detected and the door is closed another door will open revealing the new full cylinder. The carousel may or may not rotate to accomplish task.

A hydrocarbon sensor is provided to generate an analog input to the controller which registers the concentration of hydrocarbons (e.g. propane) in parts per million in the surrounding air. The hydrocarbon sensor may be positioned at the bottom of the dispenser 30. If the concentration is above the threshold value, the controller sends an output signal to the Fan 171 so the gas can be exhausted outside of the kiosk. If the gas cannot be exhausted within a certain threshold (e.g., within two minutes) or if there are a number of occurrences (e.g., three) within a certain timeframe (e.g., 30 minutes), the controller sends a signal to the computer to report the issue to the server and database and then to the web portal and the propane supplier. If a propane alert is sent out, the kiosk shuts down and displays an ‘out of service’ message. This analog reading is reported to the server and database upon every check in regardless of its value.

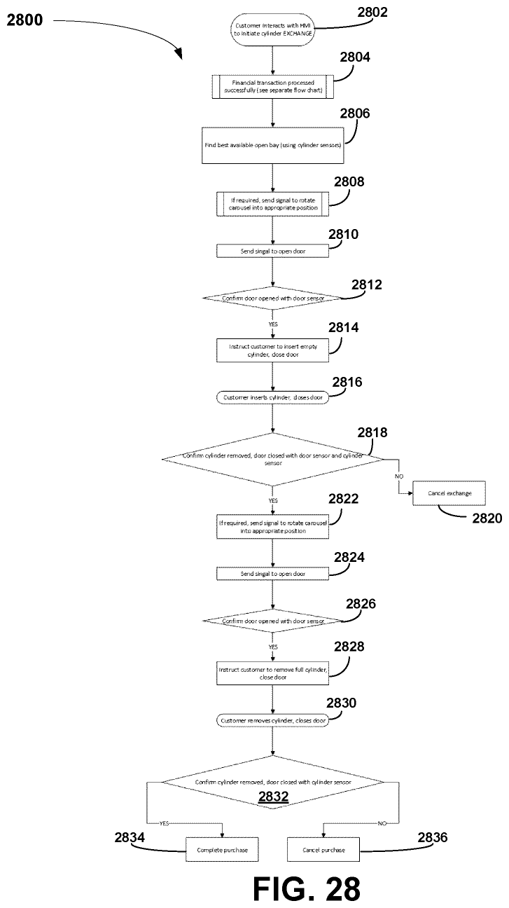

FIG. 28 illustrates, in a flowchart, an example of a method 2800 of exchanging a cylinder in a dispenser, in accordance with some embodiments. The method 2800 may be performed by the dispensing system.

At block 2802, a customer interacts with the HMI to initiate a cylinder exchange. I.e., the system receives input at the HMI.

At block 2804, a financial transaction is processed successfully (see FIG. 31).

At block 2806, the best available open bay or compartment is located using cylinder sensors. In some embodiments, load bearing criteria may be used to balance the carousel by selecting a compartment or bay that would optimize weight distribution if a cylinder was placed in that compartment.

At block 2808, a signal is sent to rotate the carousel into an appropriate position (i.e., so that the compartment behind a corresponding door is empty). If the carousel is already at the appropriate position, then this step is not required.

At block 2810, a signal is sent to open (e.g., unlock) the door.

At block 2812, the door sensor is used to confirm that the door is open.

At block 2814, a message is sent (e.g., via HMI, via speaker or text display) to the customer to insert empty cylinder and close the door.

Once the customer removes the cylinder and closes the door 2816, then at block 2818, a cylinder sensor is used (as described above) to confirm that the cylinder was removed, and a door sensor is used (as described above) to determine that the door is closed. If the door is not closed, then the exchange is cancelled 2820.

At block 2822, a signal is sent to rotate the carousel into an appropriate position (i.e., so that a full cylinder is in a compartment behind a corresponding door. If the carousel is already at the appropriate position, then this step is not required.

At block 2824, a signal is sent to open (e.g., unlock) the door.

At block 2826, the door sensor is used to confirm that the door is open.

At block 2828, a message is sent (e.g., via HMI, via speaker or text display) to the customer to remove full cylinder and close the door.

Once the customer removes the cylinder and closes the door 2830, then at block 2832, a cylinder sensor is used (as described above) to confirm that the cylinder was removed, and a door sensor is used (as described above) to determine that the door is closed. If the door is closed 2832, then the purchase is completed. If the door is not closed 2832, then the purchase is cancelled 2836. Other steps may be added to the method 2800.

In the case of an exchange, the first door is going to open for the customer to insert their empty propane cylinder. A particular door opens when the board sends an output signal to the appropriate door lock, meaning top, middle or bottom propane door respectively. (see FIG. 28)

In use, in the case that the top door opens, the microprocessor checks for an input signal from the Top cylinder sensor, immediately after it reads the input signal for the Top Door sensor which indicates that the door is closed. If controller does not read the input signal from the Top cylinder sensor, it will open the Top Door two more times by energizing the outputs for the door lock. If the board does not receive an input signal after the third attempt, it will send a command to the main board to void the transaction so the customer will not be charged. (see FIG. 28)

If the controller receives an input signal from the Top cylinder sensor and the top door is closed, it will send an output signal to an appropriate door lock of a compartment which contains a full cylinder and open the door for the customer to remove the full cylinder stored within that compartment. Once the controller detects that the door has been closed by reading the door sensor, it checks for the absence of signal from the cylinder sensor. If the board detects an input signal, it opens the door again so the customer has another opportunity to retrieve the cylinder. The machine does this one more time if the cylinder was not taken out the second time. If this happens, the board is going to “assume” that there is a malfunction of the sensor and it will send a command to charge the customer and report an error in the database. If in fact, the board does not see a signal from the cylinder sensor, it will send a command to complete the transaction charging the customer. That is to avoid losing a cylinder in the case that there was a malfunction of the cylinder sensor. The board will then send a command to report an error in the database so the sensor can be inspected and replaced if necessary.

During the purchase of a full cylinder, the paragraph above describes the process that occurs to dispense a cylinder. The sequence would be the same for doing an exchange or a purchase using different compartments. The only difference is that the controller is going to look for different input signals and also send output signals to the appropriate outputs.

Various forms of payment processing may be implemented (e.g., a point-of-sale (POS) card reader, pinpad, tap card reader, etc.) to access and utilize the dispenser, and may be processed by controller 150 in communication with suitable external payment processing platforms. Various methods of payment may be accepted, including credit and debit cards, as well as interfaces to allow the acceptance of certain codes that have been pre-purchased at a different location. The web-portal can allow for payment via a mobile application prior to the customer interacting with the physical machine and contactless payment methods may be used.

In some embodiments, POS components may handle a transaction without transferring financial data directly through the control system of the dispensing machine. The POS may facilitates transactions with different payment card technology (e.g., credit card/debit card technology, or any combination of chip+pin cards, magnetic stripe cards, tap cards, etc.) or with mobile phone payment functions (that mimic a tap card).

In some embodiments, the dispenser may process a transaction through an application on a website, a mobile application or an in-store transaction. Codes or tokens that are redeemable at the dispenser via interaction with an HMI may be provided. Receipts may be emailed to customers, and may also be texted using SMS protocol to cellular devices at the request of the customer.

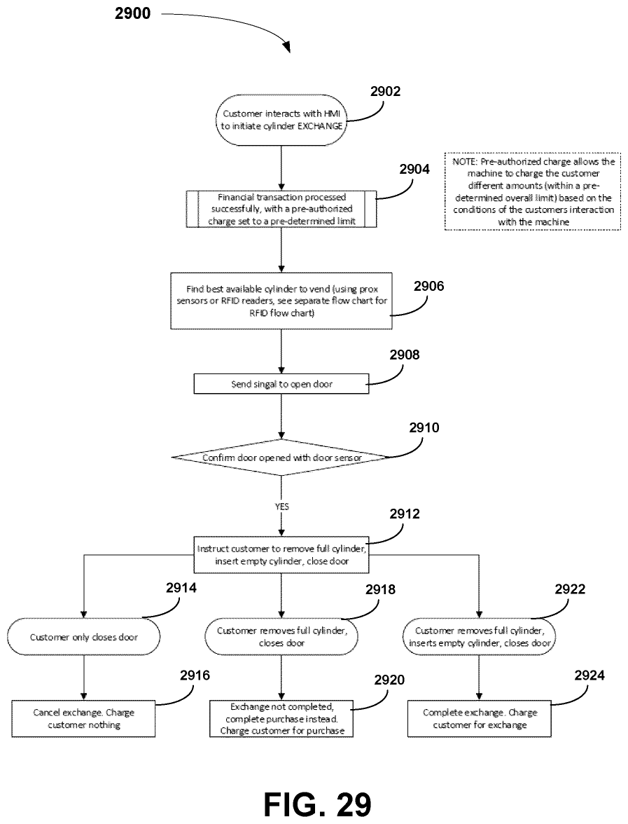

FIG. 29 illustrates, in a flowchart, another example of a method 2800 of exchanging a cylinder in a dispenser, in accordance with some embodiments. The method 2900 may be performed by the dispensing system. It should be noted that a pre-authorized charge allows the machine to charge the customer a different amount (within a pre-determined overall limit) based on the conditions of the customer interaction with the machine. As an example, a customer would engage in a preauthorization type transaction involving the exchange of a propane cylinder. The customer would interact with the dispenser and provide payment in an amount that would cover the cost of the product within the container as well as the cost of the container before the dispenser began its operation. In the event that the customer fails to return an empty propane cylinder, the customer would receive no refund for the value of the cost of the container that was part of the preauthorized charge.

At block 2902, a customer interacts with the HMI to initiate a cylinder exchange. I.e., the system receives input at the HMI.

At block 2904, a financial transaction is processed successfully with a pre-authorized charge set to a pre-determined limit.

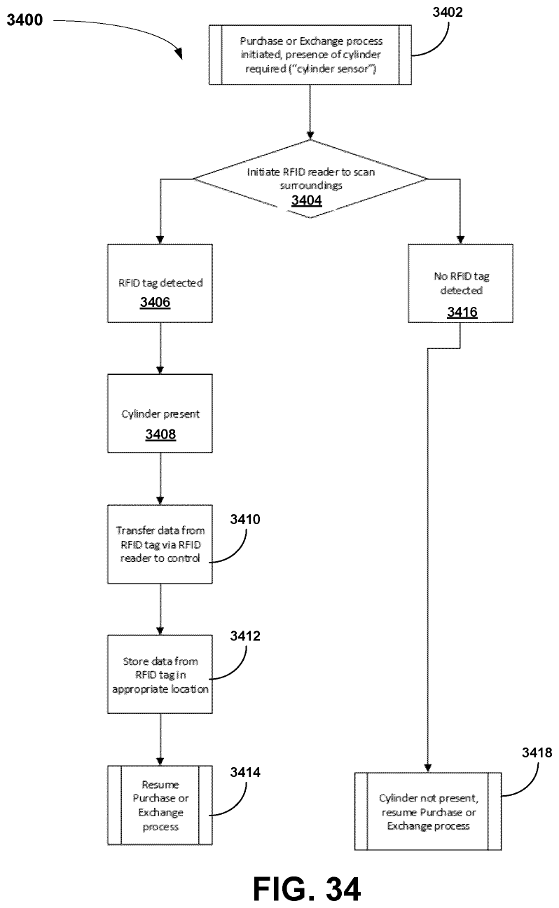

At block 2906, a best available cylinder is located to vend using proximity sensors or RFID readers (see FIG. 34)

At block 2908, a signal is sent to open (e.g., unlock) the door.

At block 2910, the door sensor is used to confirm that the door is open.

If the door is open, at block 2912, a message is sent (e.g., via HMI, via speaker or text display) to the customer to remove a full cylinder, insert an empty cylinder, and close the door.

If the customer only closes the door 2914 (i.e., the system detects that a cylinder was not inserted), then the exchange is cancelled 2916. In some embodiments, the customer is not charged.

If the customer only removes the full cylinder and closes the door 2918, then the exchange is not completed and a purchase is completed instead 2920. The customer may be charged for the purchase.

If the customer removes full cylinder, inserts an empty cylinder and closes the door 2922, then the exchange is completed 2924. The customer may be charged for the exchange. Other steps may be added to the method 2900.

Each dispenser, and its associated controller 150, can be modularly configured as a host unit (that includes the payment processing and the computer capabilities) and can be coupled with and provide direction/control to multiple (in an example, three) Servant Kiosks (dispenser 30) that have similar sensors, rotational systems, and the like, although servants do not have payment processing capability and limited control systems as they utilize the host for certain functions. Kiosks or dispensers can thus be daisy-chained in a suitable manner. For example, a Host Kiosk sized for 20 lb cylinders could be connected to a Servant Kiosk sized for 1 lb cylinders. The control system in the 201b Kiosk would handle inventory/vending of each kiosk or dispenser. Having multiple servants connected to a host lowers cost of the machine relative to inventory levels.

Kiosk maintenance and regular refilling access can be controlled and monitored electronically as well as by physical keys that can access service doors.

### Radio Frequency Identification (RFID)

In some embodiments, dispenser 30 can include an RFID scanner or reader, which can be in communication with controller 150. For example, composite cylinders (for example, made out of carbon fiber) may include an RFID chip (passive or active (broadcasting)). An RFID scanner may be used to scan compartment when product comes in, or scan entire envelope of kiosk and look at what changed and can be used to track cylinders owned by different companies based on the RFID tags.

In some embodiments, a scanner may be included in the dispenser to read barcodes, QR codes or other similar codes. Scanners can be placed internally to read codes on cylinders themselves, instead of or in combination with proximity sensors or RFID readers for cylinder detection/identification. Scanners can be customer facing on the outside of the machine to augment HMI usage to read customer codes to initiate exchange/purchase actions, or other actions. This type of scanner could also be used to augment HMI usage to trigger other actions outside of customer transactions, such as refill actions or maintenance actions.

The RFID scanner or reader may be strategically positioned so as to only read the presence of cylinders within a certain space (e.g., one scanner/reader per dispenser “level”, one scanner/reader per entire dispenser, etc.). The carousel may rotate around fixed readers to reduce need for multiple readers. This may eliminate or minimize any need for other cylinder sensors. The RFID readers may use serial communication to transfer data from RFID tags that are attached to cylinders. This identifies the cylinder, ensures that is an acceptable cylinder (based on any number of conditions, e.g., whether it is the correct “brand” of cylinder since non-acceptable brands would not have any RFID tag), and can absorb other data from the tag (e.g., is cylinder full or empty; lifetime of cylinder; where, when and by whom the cylinder was last refilled; etc.). In some embodiments, there may be one reader for the system. For example, the entire dispenser may be scanned for a cylinder upon entry, thereby deducing the location of the cylinder.

In some embodiments, LIDAR may be used to detect the cylinder. Colour sensors may also be used to determine a brand of cylinder. For example, different brands may have different colours and the colours may be used to determine if the kiosk will accept or reject the cylinder.

In some jurisdictions, due to code requirements, propane cylinders need to be placed upright in dispensers or kiosks. In some embodiments, with the 20 pound cylinder dispenser, this is performed mechanically with a bracket that physically prevents the cylinder from being inserted upside down. With the one pound cylinder dispenser/kiosk, due to its higher inventory, this would be expensive and difficult to accomplish. The geometry of the smaller one pound cylinders also makes this difficult.

In some embodiments (e.g. the dispenser which vends one pound cylinders), the dispenser/kiosk 50 and cylinders may include radio frequency identifier (RFID) tags and readers that are positioned strategically. For example, an RFID tag may be located at the bottom of a cylinder. The RFID reader may be placed so that it aligns with the bottom of a cylinder. If the cylinder is upside down, then the RFID reader cannot read the RFID tag (and reject the cylinder or provide an error message to a user/operator). RFID tags can also be used for inventory detection, inventory tracking, and other logistical purposes. RFID tags can also distinguish between different brands of cylinders (for example, when the desired brand has an RFID tag and the other brand does not).

In some embodiments, information may be read to an RFID tag. Information may also be updated and/or stored in a memory associated with the RFID tag. For example, when a full cylinder is added to a dispenser, a memory associated with the RFID tag may be updated to include information about the cylinder's location, including in a particular level or a particular compartment. In some embodiments, levels and/or compartments may be serialized.

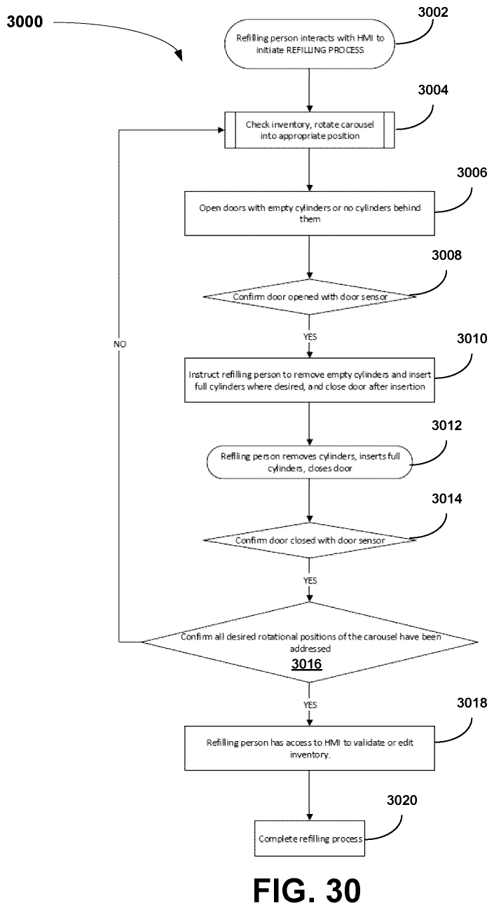

FIG. 30 illustrates, in a flowchart, an example of a method 3000 of refilling cylinders in a dispenser, in accordance with some embodiments. The method 3000 may be performed by the dispensing system.

At block 3002, a refilling person interacts with the HMI to initiate a refilling process. I.e., the system receives input at the HMI.

At block 3004, inventory is checked and the carousel is rotated into an “appropriate” position. I.e., compartments that have empty or no cylinders are noted, and the carousel is rotated to a compartment having an empty cylinder.

At block 3006, a door with an empty cylinder (or no cylinder) is opened (e.g., unlocked).

At block 3008, the door sensor is used to confirm that the door is open.

If the door is open, at block 3010, a message is sent (e.g., via HMI, via speaker or text display) to the refilling person to remove the empty cylinder (if there is one), insert a full cylinder, and close the door.

Once the refilling person removes the empty cylinder (if there is one), inserts the full cylinder (where desired) and closes the door 3012, then at block 3014, the door sensor is used to confirm that the door is closed (e.g., locked).

If all noted compartments (e.g., desired rotational positions of the carousel) have not been addressed 3016, then block 3004 is repeated. Otherwise 3016, the refilling person accesses the HMI to input a validation or edit of the inventory 3018. Other steps may be added to the method 3000.

FIG. 31 illustrates, in a flowchart, an example of a method 3100 of a financial transaction process, in accordance with some embodiments. The method 3000 may be performed by the dispensing system.

At block 3102, a purchase or exchange process is initiated and a payment transaction is requested.

At block 3104, an HMI or other output interface is used to instruct a customer to swipe, tap or insert a code for a payment card (or phone payment app).

At block 3106, a card reader receives a card swipe. At block 3108, a card reader receives an inserted card. At block 3110, a card reader receives a near field message following a card tap.

At block 3112, encrypted payment data is sent to an external transaction processor using communications means.

At block 3114, the transaction processor receives and processes the transaction data. If the card reader receives a first “card failed” message 3116, then block 3104 may be repeated. Otherwise if the card reader receives a second “card failed” message 3116, then the financial transaction is cancelled, and the exchange or purchase is cancelled 3118.

At block 3120, the card reader receives a “card approved” message. An amount is charged to the card 3122, and the financial transaction is completed. The exchange or purchase is continued 3124.

For pre-authorized transactions, following receipt of a “card approved” message 3120, the HMI may be used to display a request to the user to approve a pre-authorized charge at or below an amount 3130. If a consent is received at the HMI 3132, then the card is pre-authorized to be charged at or below the amount 3134. The purchase or exchange process determines and provides the charge amount for a particular purchase 3136. The customer card is charged that amount 3138 and the financial transaction is completed.

At block 3126, the HMI may receive a pre-paid code input from the customer. The pre-paid code may be redeemed 3128, and the financial transaction is competed 3124. Other steps may be added to the method 3100.

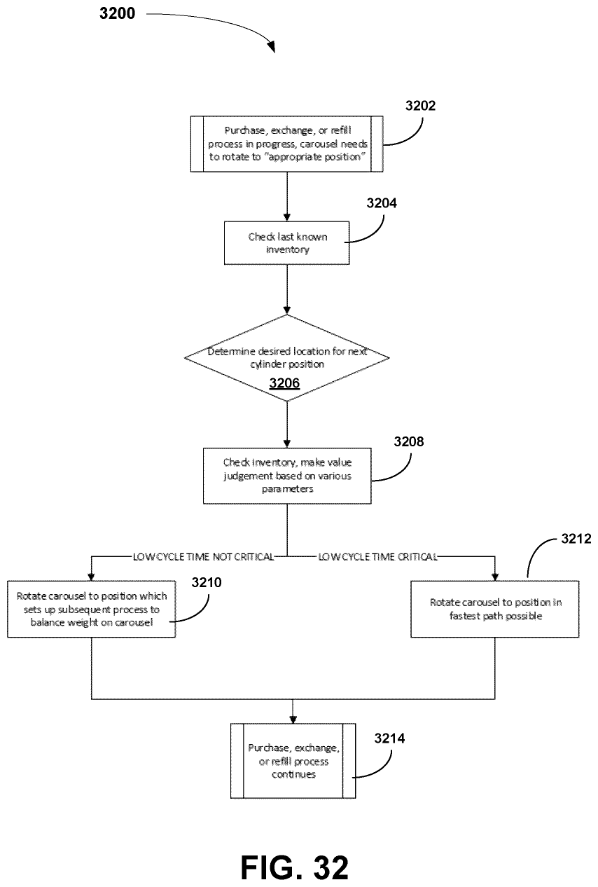

FIG. 32 illustrates, in a flowchart, an example of a method 3200 of inventory control and preparation, in accordance with some embodiments. The method 3200 may be performed by the dispensing system.

At block 3202, a purchase, exchange, or refill process is in progress. The carousel is to rotate to an “appropriate” position.

At block 3204, the last known inventory is checked.

At block 3206, a desired location for the next cylinder position is determined.

At block 3208, inventory is checked and a determination is made based on various parameters. In some embodiments, parameters include one or more of: specific details from RFID tags within the dispenser, which compartments are empty, the position of the carousel preparing for a purchase of available product, etc.

At block 3210, when low cycle time is not critical, for example when a customer is not waiting for the dispenser to complete its cycle, the carousel is rotated to an optimal position which provides a more balanced weight distribution on the carousel. For example, the system may use the ‘home’ position described above as a reference point. The system can determine where the carousel is currently positioned based on the reference point and where the carousel needs to be positioned. The carousel may then be rotated from where it is to where it needs to be in the direction that is shortest. In some embodiments, the system will know where all cylinders are located in the carousel and can determine which full cylinder's removal would be optimal for weight distribution. The carousel may then be rotated such that the determined full cylinder is presented to the customer.

At block 3212, when low cycle time is critical, the carousel is rotated to the desired position in a fastest possible path. For example, if the carousel needs to be set to its ‘home’ position, then it would be rotated in the direction that is closer to the ‘home’ position.

At block 3214, the purchase, exchange, or refill process continues once the carousel is in its appropriate position. Other steps may be added to the method 3200.

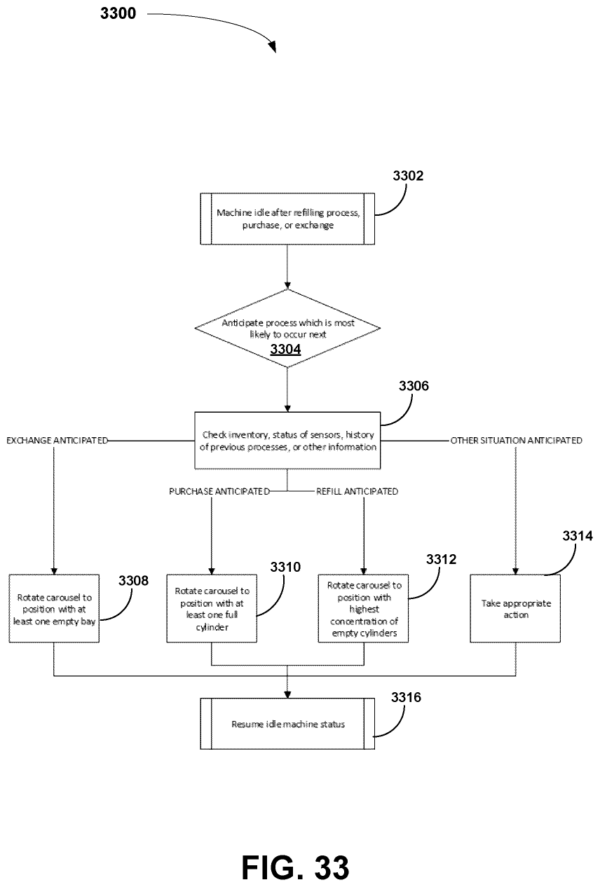

FIG. 33 illustrates, in a flowchart, an example of a method 3300 of resetting a dispenser, in accordance with some embodiments. The method 3300 may be performed by the dispensing system.

At block 3302, the dispensing machine is idle after a refilling process, a purchase or an exchange.

At block 3304, the process which is most likely to occur is anticipated 3306. An inventory, status of sensors, history of previous processes, or other information is reviewed to estimate the process most likely to occur. For example, the carousel may be staged (or set) such that a full cylinder is ready at a door, thereby minimizing cycle time (e.g., wait time for rotation of the carousel) for a customer. In a pre-authorized purchase or exchange example, the carousel is pre-rotated so that a full cylinder is ready for the customer to remove from a compartment. The customer may then only need to wait for the door to be unlocked (open) rather than for the carousel to be rotated. The customer may then remove the full cylinder and insert an empty cylinder in its place (for an exchange). In a non-pre-authorized purchase or exchange example, the carousel may be pre-set to have either a full cylinder ready for a purchase, or an empty compartment ready for an exchange. Purchase and/or exchange statistics may be used to estimate if a purchase or exchange setting is ideal. In some embodiments, future weight distribution may be taken into consideration where the full cylinder ready for purchase is selected to be the one whose removal would be optimal for weight distribution.

At block 3308, an exchange is anticipated, so the carousel is rotated to position a door with at least one empty compartment or bay.

At block 3310, a purchase is anticipated, so the carousel is rotated to position a door with at least one full cylinder.

At block 3312, a refill is anticipated, so the carousel is rotated to position the doors with the highest concentration of empty cylinders.

At block 3314, another situation is anticipated, so action appropriate to that situation is taken.

At block 3316, once action is taken based on the anticipated process, the machine resumes idle status. Other steps may be added to the method 3300.

FIG. 34 illustrates, in a flowchart, an example of an RFID process 3400, in accordance with some embodiments. The method 3400 may be performed by the dispensing system having a cylinder sensor.

At block 3402, a purchase or exchange process is initiated where the presence of a cylinder is required.

At block 3404, an RFID reader is initiated to scan the surroundings.

At block 3406, an RFID tag is detected. This indicates 3408 that a cylinder is present. Data is transferred 3410 from the RFID tag via an RFID reader to a controller of the dispensing system. Data is stored 3412 from the RFID tag in an appropriate location, such as a memory. The purchase or exchange process may now resume 3414.

At block 3416, no RFID tag is detected. This indicates that a cylinder is not present, and the purchase or exchange process may resume 3418 based on this indication. Other steps may be added to the method 3400.

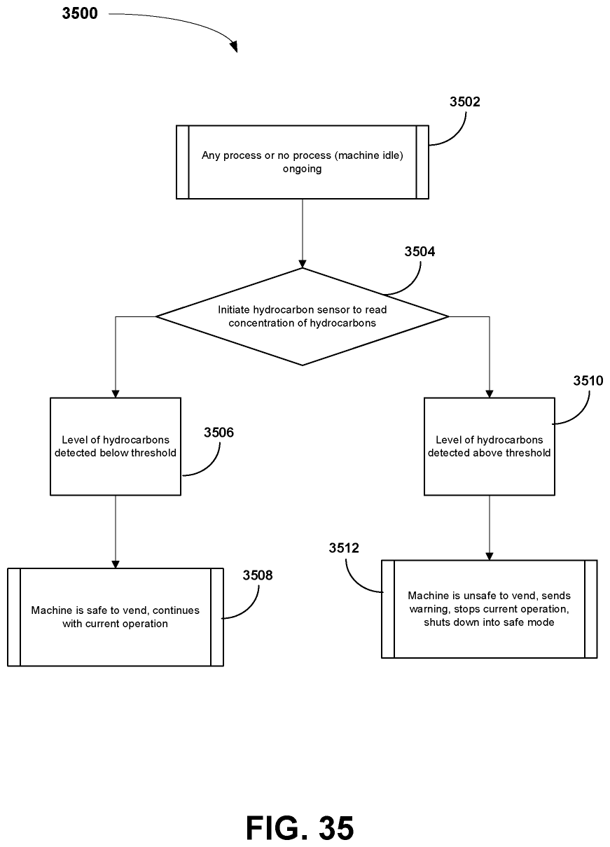

FIG. 35 illustrates, in a flowchart, an example of a method of determining that it is save to vend 3500, in accordance with some embodiments. The method 3500 may be performed by the dispensing system.

At block 3502, the dispensing machine may be idle or may be active with a process. At all times the dispensing machine should have a concentration of hydrocarbons below a threshold level. A test may be conducted at any time including, when the dispensing machine is idle or when the dispensing machine is in operation. I.e., before switching from idle to active, before initiating a process, or in between any two steps of an active process.

At block 3504, a hydrocarbon sensor is initiated to read concentration levels of hydrocarbons in the dispensing machine. When the hydrocarbons are detected at a level below a threshold 3506, then the dispensing machine is safe to vend and may continue with its current operation 3508 or initiate another operation. When the hydrocarbons are detected at a level above the threshold 3510, then the machine is unsafe to vend and may issue a warning, stop a current operation, or shut down and go into a safe mode 3512. Other steps may be added to the method 3500.

Other components may be added to the dispensing system provided that the components are safe to use in a hazardous environment and the components are coupled with the dispensing system in a manner that allows the dispensing system to maintain its safety standard with respect to hazardous environments. Such components may include a speaker (to allow for communication to customers, or maintenance or refilling personnel; or for providing an alternate communication method for accessibility), a microphone (for voice control during transactions, including to assist with accessibility; and for troubleshooting or maintenance (for remote communication with technicians to help diagnose and troubleshoot issues, or for taking samples of noise during machine operation to determine whether the machine is operating properly), different power supplies (such as converting alternating current (AC) power from a building or existing infrastructure to direct current (DC) power), external light emitting diodes (LEDs) (to light on certain conditions to illuminate the kiosk and area around the kiosk if the area is dark or if a person is present),

In some embodiments, the system provides an ability to program purchase/exchange prices via the Portal for an individual machine or for a group of machines based on a number of conditions available in the metadata of the portal. E.g. a change prices for all machines in Ontario, change exchange price on weekends, etc.

In some embodiments, the system provides an ability to run advertising using the HMI and/or speaker. Advertisements may be changed based on date/time, location etc. Ability to advertise based on conditions determined by metadata in the Portal. The motion sensor/ambient light sensor may be used to trigger conditions for advertisement.

In some embodiments, customer facing messages may be displayed on the HMI and/or communicated via a speaker. Messages such as “Sold Out”, “Kiosk Out of Service”, etc., may be displayed to customer based on machine/portal conditions. The machine can greet a potential customer, play audio of instructions on how to start a transaction, etc. This may be based on motion sensor input.

In some embodiments, a refill/maintenance menu may be displayed. On the machine, there may be a menu accessible on the HMI with the use of a passcode. Passcodes can be changed based on certain conditions using the Portal. The menu may allow access to initiate a refilling process and access to manually control the machine (e.g., open (e.g., unlock) doors, rotate carousel, etc.) which helps during troubleshooting issues.

In some embodiment, the dispensing machine may comply with regulations in regards to accessibility (e.g., Americans with Disabilities Act (ADA)). Customer interaction points are in appropriate location and below max height required by regulations. For example, there may be a selection button/function that triggers an “Accessibility mode”, which can take a variety of forms. There may be a mode for sight challenged individuals that communicates instructions via speaker, makes touch screen buttons larger, uses braille buttons included on the Pin Pad, etc. There may be a mode for those in wheelchairs or otherwise physically impaired where the machine vends through doors below a certain height.

In some embodiments, a receipt and/or email receipt may be provided. Receipts can be printed at the machine via receipt printer, or sent to customer via email after customer inputs email via HMI. Receipts may also be stored in a portal memory so a customer can request and access them at a later date. Receipt functionality may also be built into a mobile application in the event of a purchase through a mobile application.

In some embodiments, lighting may be provided. Internal lights may be controlled on separate circuits, allowing controller to turn them on/off based on certain conditions. For example, one light per door, turned on when door is open, turned off when closed, etc., to assist customers see inside a dark dispensing machine. External lights may be turned on/off based on a number of conditions, including motion sensor, ambient light sensor, date/time, portal metadata, etc.

In some embodiments, manual override features may be included. For example, in the event of a power outage, or other reason that renders the dispensing machine non-operable, the kiosk can be used like a manual propane exchange cage where an attendant handles inventory. I.e., left and/or right service doors may be accessible by authorized personnel using a lock and key. When doors are open (e.g., unlocked), electromechanical door locks can be opened by integrated mechanical override lever. The carousel can be rotated by using a mechanical override lever that is integrated in the electromechanical brake (for example, pull down on the lever while other hand rotates carousel).

In some embodiments, RFID tank sensing may be provided. RFID readers may be positioned strategically to only detect tags if the cylinder is in a correct position. This ensures orientation of the cylinder (i.e., right side up vs upside down). Cylinders may be required by some regulations to be stored upright.

In some embodiments, a camera may be provided. An external facing camera may be used to discourage theft, collect user feedback, and/or to augment user interaction with Kiosk based on the user's movements. Instead of a proximity sensor/RFID reader, internally facing cameras can use visual processing to determine the presence of a cylinder, what brand it is, what size it is, etc. An internal facing camera can also be used to monitor machine performance, including remotely via the Portal.

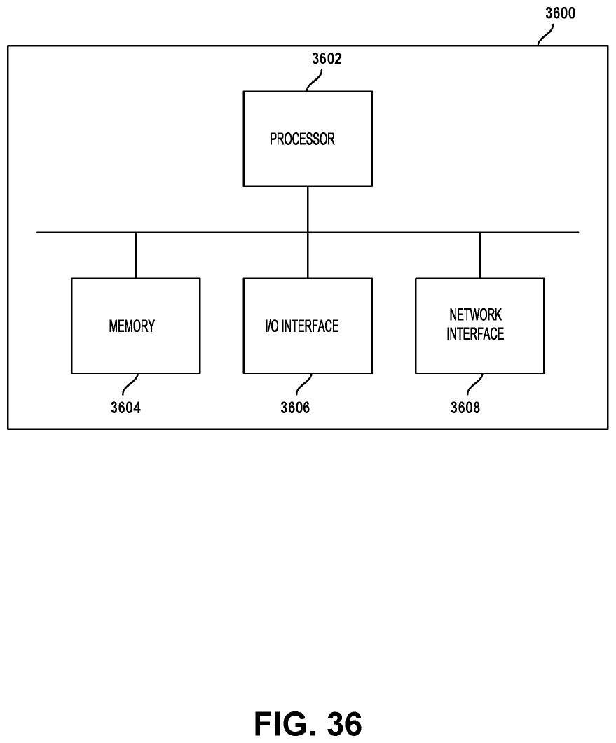

FIG. 36 is a schematic diagram of a computing device 3600 such as a server. As depicted, the computing device includes at least one processor 3602, memory 3604, at least one I/O interface 3606, and at least one network interface 3608.

Processor 3602 may be an Intel or AMD x86 or x64, PowerPC, ARM processor, or the like. Memory 3604 may include a suitable combination of computer memory that is located either internally or externally such as, for example, random-access memory (RAM), read-only memory (ROM), compact disc read-only memory (CDROM).

Each I/O interface 3606 enables computing device 3600 to interconnect with one or more input devices, such as a keyboard, mouse, camera, touch screen and a microphone, or with one or more output devices such as a display screen and a speaker.

Each network interface 3608 enables computing device 3600 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others.

Of course, the above-described embodiments are intended to be illustrative only and in no way limiting. The described embodiments are susceptible to many modifications of form, arrangement of parts, details and order of operation. The disclosure is intended to encompass all such modification within its scope, as defined by the claims.

The discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

Although the embodiments have been described in detail, it should be understood that various changes, substitutions and alterations can be made herein.

Moreover, the scope of the present application is not intended to be limited to the particular embodiments of the apparatus, process, machine, manufacture, composition of matter, means, methods and steps described in the specification.

As can be understood, the examples described above and illustrated are intended to be exemplary only.

1. A dispensing machine comprising:
a main frame with a bottom wall, top wall and side walls defining an enclosure for storage and dispensing of containers of product which require storage conditions that satisfy requirements of a hazardous environment;
a carousel rotatably mounted atop said bottom wall about a vertical axis of rotation, said carousel having a plurality of separate compartments located around said axis for receiving a container in a compartment;
a door hingedly mounted to said main frame and movable to and from an open position allowing access to said compartment and a closed position limiting access to said compartment; and
a driver mounted on said main frame and engaged with said carousel for drivingly rotating said carousel about said axis, and positioning the compartment behind the door.

2. The dispensing machine as claimed in claim 1, wherein said driver comprises a small motor coupled with a mechanical power transmission system wherein the driver and all electrical components in the dispensing machine are suitable for use in a hazardous environment.

3. The dispensing machine as claimed in claim 2, wherein the driver and all electrical components in the dispensing machine are low power, non-sparking, or intrinsically safe.

4. The dispensing machine as claimed in claim 2, wherein said small motor is configured to rotate said carousel about said axis in either direction.

5. The dispensing machine as claimed in claim 2, where the mechanical power transmission system comprises at least one of:
a gear system;
a belt and pulley system;
a worm gear system;
a sprocket and chain system; or
a direct drive system.

6. The dispensing machine as claimed in claim 1, comprising a locking mechanism mounted on said main frame and releasably engageable with said carousel limiting movement of said carousel.

7. The dispensing machine as claimed in claim 6, wherein the locking mechanism comprises at least one of:
a claw like fixture to retain the carousel;
an electromechanical brake; or
a motor holding torque to retain the carousel.

8. (canceled)

9. The dispensing machine as claimed in claim 1, wherein said carousel has a plurality of intermediate walls extending radially outward from said axis separating said compartments apart.

10. (canceled)

11. The dispensing machine as claimed in claim 1, wherein said carousel frame includes a projection located in each compartment limiting insertion of said item in a compartment to an upright position.

12. (canceled)

13. The dispensing machine as claimed in claim 1, comprising a level sensor for detecting an amount of gas or liquid in a container.

14. (canceled)

15. (canceled)

16. (canceled)

17. (canceled)

18. The dispensing machine as claimed in claim 1, comprising a sensor or scanner for detecting a presence and location of any container inserted onto the carousel.

19. The dispensing machine as claimed in claim 18, wherein the scanner scans an RFID tag affixed to the container.

20. (canceled)

21. (canceled)

22. (canceled)

23. The dispensing machine as claimed in claim 1, comprising a processor and a memory storing instructions which when executed configure the dispensing machine to:
determine that a container is in a proper position based on the scan of the container; and
determine at least one of:
that a container is not in a proper position based on a scan of a flag attached to the container; or
that a container is expired based on a scan of a flag attached to the container;
at least one of:
accept the container;
send or display a message confirming acceptance of the container;
reject the container; and
send or display a message rejecting the container.

24. (canceled)

25. (canceled)

26. (canceled)

27. (canceled)

28. (canceled)

29. (canceled)

30. A method of vending product which require storage conditions that satisfy requirements of a hazardous environment, the method comprising:
receiving a hydrocarbon reading from a hydrocarbon sensor in a dispensing machine;
and at least one of:
when the level of hydrocarbons is below a threshold:
confirming that the dispensing machine is safe to vend; or
sending or displaying a message to continue operation;
when the level of hydrocarbons is above the threshold:
confirming that the dispensing machine is unsafe to vend;
sending or displaying a warning message;
shutting down or transitioning the dispensing machine to a safe mode; or
stopping any current operation of the dispensing machine.

31. The method as claims in claim 30, comprising:
when the level of hydrocarbons is below the threshold:
processing a financial transaction;
determining an available full container to vend;
signalling a door associated with a compartment containing the full container to open; and
displaying instructions to remove the full container.

32. (canceled)

33. The method as claimed in claim 31, comprising:
receiving a first confirmation that the full container has been removed, or receiving a second confirmation the full container has not been removed;
receiving a third confirmation that the door associated with the compartment that previously contained the full container is closed, or receiving a fourth confirmation the door associated with the compartment containing the full container is open
completing a purchase of the full container when the first and third confirmations are received; or cancelling the purchase of the full container when at least one of the second and further confirmations are received.

34. (canceled)

35. (canceled)

36. The method as claimed in claim 31, comprising:
signaling a door associated with the empty compartment to open;
displaying instructions to insert an empty container;
receiving a confirmation that the empty container has been inserted into the previously empty compartment;
receiving a confirmation that the door associated with the previously empty compartment is closed; and
completing an exchange for the empty container.

37. (canceled)

38. The method as claimed in claim 32, comprising:
at least one of:
confirming that the empty container has not been inserted; or
confirming that the door associated with the previously empty compartment is open; and
cancelling an exchange for the empty container.

39. The method as claimed in claim 32, comprising:
receiving a purchase; and
generating and sending a code or token for the purchase, the code or token to be used as payment for the purchase.

40. (canceled)

41. A method of refilling a dispensing machine used to vend product which require storage conditions that satisfy requirements of a hazardous environment, the method comprising:
checking an inventory of the dispensing machine; and
for each compartment on a carousel containing no container or an empty container:
rotating a carousel of the dispensing machine such that a door is aligned with that compartment;
signaling the door to open;
receiving confirmation that the compartment contains a full container; and
receiving confirmation that the door is closed.
